(19) United States
(12) Patent Application Publication
(10) Pub. No.: US 2024/0049721 A1
(43) Pub. Date: Feb. 15, 2024

(54) COMPOSITIONS AND METHODS FOR CONTROLLING FUNGI

(71) Applicant: AgroSpheres, Inc., Charlottesville, VA (US)

(72) Inventors: Ameer Hamza SHAKEEL, Charlottesville, VA (US); Sepehr ZOMORODI, Charlottesville, VA (US); Sergio CARBALLO, Charlottesville, VA (US); Payam POURTAHERI, Charlottesville, VA (US); Joseph FRANK, Charlottesville, VA (US)

(21) Appl. No.: 18/257,995

(22) PCT Filed: Dec. 22, 2021
(86) PCT No.: PCT/US2021/065009

§ 371 Date: Jun. 16, 2023

Related U.S. Application Data
(60) Provisional application No. 63/129,435, filed on Dec. 22, 2020.

(51) Int. Cl. A01N 63/20; A01N 31/02; A01N 31/16

(52) U.S. Cl. CPC A01N 63/20; A01N 31/02; A01N 31/16

(57) ABSTRACT

The present disclosure provides compositions and methods for controlling fungal pests with bioactive agents. Also, the present disclosure provides fungicidal compositions and methods of using the formulations containing minicells and bioactive agents for targeted delivery and controlled release to enhance control of pathogenic fungi in an environment-friendly, stable and scalable manner.

### CROSS-REFERENCE TO RELATED APPLICATIONS

This application claims the benefit of priority to U.S. provisional application No. 63/129,435 filed on Dec. 22, 2020, which is hereby incorporated by reference in its entirety.

### FIELD

This present disclosure relates generally to fungicidal compositions and methods of using same to control various pests such as fungi and their spores. More particularly, the disclosure relates to compositions and formulations comprising minicell systems for delivery of bioactive agents with fungicidal activity for effective control of parasitic fungi and fungal-like microorganisms.

### BACKGROUND

Fungicides are well known to control many plant pathogenic fungi. During the last two decades, about 100,000 chemicals have been produced and used commercially. Among them, about 17% of applied pesticides are fungicides (Mitchell at el., 2002 and Helsel, 1987). Fungicides plays an important role in modern agriculture for the control of fungal pathogens and the protection of plants.

However, fungicides negatively affects the environment and decline in the number of non-pathogenic soil fungi. Microorganisms play an important role in many soil biological processes, including nitrogen transformations, organic matter decomposition, nutrient release and availability, as well as stabilize the soil structure and affect its fertility, soil texture. Soil microflora can undergo direct and indirect impacts of toxic substances of fungicides introduced to soil. The fungicides can affect biochemical processes within soil microorganisms and fertility of the soil, thereby causing water pollution as well as soil pollution. Also, they can give hazardous affect on human health. Furthermore, the indiscriminate use of chemicals or synthetic chemical fungicides gave rise to development of fungicides resistance.

Considering the adverse and alarming effects of synthetic pesticides on environment and natural habitats and the promotion of environmentally sustainable and organic agriculture, there is a need of fungicide alternatives such as the use of natural plant products as biofungicides. Because biofungicides have a disadvantage of a relatively short persistence in the environment and susceptibility to unfavorable environmental condition, there is another unmet need a new delivery and release system for biofungicides with a synergistic effect in a stable, controlled and scalable manner.

### SUMMARY OF THE DISCLOSURE

The present disclosure provides a fungicidal composition for controlling one or more fungi comprising: (i) a minicell and (ii) a bioactive agent having fungicidal activity. In embodiments, the bioactive agent is an essential oil. In embodiments, the one or more fungi are controlled with application of said composition to a locus In embodiments, the minicell enhances stability and fungicidal activity of said bioactive agent in an environmental stress. In embodiments, the minicell is an achromosomal bacterial cell. In embodiments, the minicell is capable of encapsulating the bioactive agent. In embodiments, the bioactive agent is present within the minicell. In embodiments, said essential oil comprises an eugenol, a geraniol, or a thymol. In embodiments, said essential oil is an eugenol. In embodiments, said essential oil is a geraniol. In embodiments, said essential oil is a thymol. In embodiments, the minicell and the active agent are present in a weight-to-weight ratio of about 5:1 to about 1:5 in the composition. In embodiments, the minicell and the active agent are present in a weight-to-weight ratio of about 1:1. In embodiments, the minicell is less than or equal tol μm in diameter. In embodiments, the locus is a plant, a plant part thereof, or soil on which the plant grows or is supposed to grow. In embodiments, the locus is one or more fungi. In embodiments, the locus is one or more fungal-like microorganisms. In embodiments, said application of the fungicidal composition improves growth in one or more crops. In embodiments, said improved growth is selected from the group consisting of preventively and/or curatively controlling pathogenic fungi and/or nematodes, resistance management, and improved plant physiology effects selected from enhanced root growth, improved greening, improved water use efficiency, improved nitrogen-use efficiency, delayed senescence and enhanced yield. In embodiments, said environmental stress is temperature at 37° C. or higher. In embodiments, the bioactive agent in the presence of the minicell has at least 1% higher fungicidal activity than the bioactive agent alone 24 hours after treatment of said composition. In embodiments, said fungicidal composition further comprises a surfactant. In embodiments, the composition is applied in a liquid form or a soluble, dry powder form.

The present disclosure provides a method of controlling one or more fungi, the method comprising: applying an fungicidal composition to a locus, wherein said fungicidal composition comprising: (i) a minicell and (ii) a bioactive agent having fungicidal activity. In embodiments of the method, the bioactive agent is an essential oil. In embodiments of the method, the one or more fungi are controlled with application of said composition to a locus. In embodiments of the method, the minicell enhances stability and fungicidal activity of said bioactive agent in an environmental stress. In embodiments of the method, the minicell is an achromosomal bacterial cell. In embodiments of the method, the minicell is capable of encapsulating the bioactive agent. In embodiments of the method, the bioactive agent is present within the minicell. In embodiments of the method, said essential oil comprises an eugenol, a geraniol, or a thymol. In embodiments of the method, said essential oil is an eugenol. In embodiments of the method, said essential oil is a geraniol. In embodiments of the method, said essential oil is a thymol. In embodiments of the method, the minicell and the active agent are present in a weight-to-weight ratio of about 5:1 to about 1:5 in the composition. In embodiments of the method, the minicell and the active agent are present in a weight-to-weight ratio of about 1:1. In embodiments of the method, the minicell is less than or equal tol p.m in diameter. In embodiments of the method, the locus is a plant, a plant part thereof, or soil on which the plant grows or is supposed to grow. In embodiments of the method, the locus is one or more fungi or fungal-like microorganisms. In embodiments of the method, the locus is one or more fungi or fungal-like microorganisms. In embodiments of the method, said application of the method improves growth in one or more crops. In embodiments of the method, said improved growth is selected from the group consisting of preventively and/or curatively controlling pathogenic fungi and/or nematodes, resistance management, and improved plant physiology effects selected from enhanced root growth, improved greening, improved water use efficiency, improved nitrogen-use efficiency, delayed senescence and enhanced yield. In embodiments of the method, said environmental stress is temperature at 37° C. or higher. In embodiments of the method, the bioactive agent in the presence of the minicell has at least 1% higher fungicidal activity than the bioactive agent alone 24 hours after treatment of said composition. In embodiments of the method, said method further comprises a surfactant. In embodiments of the method, the composition is applied in a liquid form or a soluble, dry powder form.

### BRIEF DESCRIPTION OF THE FIGURES

FIGS. 1A-1C illustrates scanning electron microscope images of an unpurified sample of AgriCell producing E. coli. (FIG. 1A; scale bar 1 μm), a purified fraction of AgriCell showing the absence of rod-shaped parent cells (FIG. 1B; scale bar 2 μm) and magnification image showing the morphology and relatively uniform particle size of purified AgriCells (FIG. 1C; scale bar 200 nm).

FIG. 2 illustrates size distribution of an un-purified AgriCell production batch and a purified AgriCell batch. Two humps represent different populations composed by larger replicating parent cells (mean diameter about 1.0 μm) and smaller anucleate AgriCells (mean diameter about 0.5 μm). The size distribution of the purified AgriCell production shows that only small anucleate AgriCells are present (purity>99%).

FIG. 3 illustrates evaluation of loading efficacy for essential oils into AgriCell (AC). FIG. 3 shows that model essential oils (EOs) (e.g. eugenol, geraniol, and thymol, respectively) are encapsulated into AC. Bars show the correlation between original concentration of EO (200 mg/mL) and the final concentration encapsulated into AC. Line shows the percentage encapsulated EO for each formulation.

FIG. 4A illustrates AgriCell encapsulating eugenol (right tube), which shows improved chemical stability to changes in pH, when compared to Eugenol-encapsulating liposomal formulation (left tube). AgriCell-encapsulated eugenol showed improved stability when pH was adjusted to simulate low acidic conditions (pH 1.2). FIGS. 4B-4C illustrates the improved physical stability of AgriCell-encapsulated eugenol (right tube) against a Eugenol-encapsulated liposomal formulation (left tube) on day 1 (FIG. 4B) and day 30 (FIG. 4C) after storage under controlled conditions (temperature 25° C., relative humidity 30% and pH 7.2). All samples were diluted 1:10 with deionized water.

FIG. 5 illustrates evaluation of the protective effect of AgriCell on thermal degradation of essential oils at 40° C. Initial concentration of essential oil formulations was about 200 mg/mL, whereas the AgriCell concentration was about 100 mg/mL.

FIG. 6 illustrates evaluation of the protective effect of AgriCell on auto-oxidative degradation of essential oils under UV and Visible (Vis) light exposure. Initial concentration of essential oil formulations was about 200 mg/mL, whereas the AgriCell concentration was 100 mg/mL.

FIGS. 7A-7C illustrates cumulative percentage release of model essential oils (EOs), eugenol (FIG. 7A), geraniol (FIG. 7B), and thymol (FIG. 7C) from an un-coated free form (i.e. not encapsulated into AgriCell/minicell), AgriCell/minicell platform (i.e. encapsulated into AgriCell/minicell) and AgriCell/minicell surface coated by chitosan biopolymer (MC-CHT). Release media was composed by PBS, ethanol and Tween 80 emulsifier (140:59:1 v/v/v). Dialysis cassette membrane MWCO 8-10 kDa. FIG. 7A shows percentage release of (i) Eug (Eugenol 100 mg/mL); (ii) MC-Eug (Eugenol 100 mg/mL loaded with AgriCell/Minicell platform 100 mg/mL); and (iii) MC-Eug-CHT (Eugenol 100 mg/mL loaded with AgriCell/Minicell-CHT platform (AC 100 mg/mL and CHT 20 mg/mL, weight ratio 1:1). FIG. 7B shows percentage release of (i) geraniol (100 mg/mL); (ii) MC-Gera (Geraniol 100 mg/mL loaded with AgriCell/Minicell platform 100 mg/mL); and (iii) MC-Gera-CHT (Geraniol 100 mg/mL loaded with AgriCell/Minicell-CHT platform (AC 100 mg/mL and CHT 20 mg/mL, weight ratio 1:1). FIG. 7C shows percentage release of (i) Thymol (100 mg/mL); (ii) MC-Thym (Thymol 100 mg/mL loaded with AgriCell/Minicell platform 100 mg/mL); and (iii) MC-Thym-CHT (Thymol 100 mg/mL loaded with AgriCell/Minicell-CHT platform (AC 100 mg/mL and CHT 20 mg/mL, weight ratio 1:1).

FIG. 8 illustrates biofungicide efficacy against Botrytis cinerea at different dilution rates (100×,1000×, 10,000× dilutions). The tested biofungicides are essential oils (EOs); MC+Eugenol (Eugenol encapsulated by minicell), MC+Thymol (Thymol encapsulated by minicell), MC+Geraniol (Geraniol encapsulated by minicell), and MC+Eug+Thy+Gera (Eugenol:Thymol:Geraniol encapsulated by minicell). Percent (%) inhibition of B. cinerea for each of minicell-encapsulated EO biofungicides was presented in comparison to free EO biofungicide controls without minicell treated/encapsulated.

FIG. 9 illustrates thermogravimetric Analysis (“TGA”) between AgriCell encapsulated Thymol (“AC Thymol”) and free Thymol (“Thymol”; not encapsulated by AgriCell) along with gradual increase of temperature from 37° C. to 500° C.

FIG. 10A shows phytotoxicity testing of AgriCell-encapsulated biofungicide (AC-Thyme) on Hemp leaf, while FIG. 10B shows phytotoxicity testing of unencapsulated biofungicide (AC-Thyme) for Hemp leaves.

### DETAILED DESCRIPTION

To control or prevent the growth of fungi with biofungicides, new fungicidal compositions and formulations are required to ensure a safe, non-toxic, scalable, and cost-effective delivery of bioactive ingredients/agents with fungicidal activity.

The present disclosure provides use of minicells as a novel delivery platform comprising bioactive agents such as biofungicides for the purpose of control of pathogenic fungi, fungal-like microorganisms, and fungal diseases. Also, disclosed are methods of controlling, killing or suppressing fungi and fungal-like microorganisms using an fungicidal composition or formulation taught herein.

### Definitions

While the following terms are believed to be well understood by one of ordinary skill in the art, the following definitions are set forth to facilitate explanation of the presently disclosed subject matter.

The term “a” or “an” refers to one or more of that entity, i.e. can refer to a plural referents. As such, the terms “a” or “an”, “one or more” and “at least one” are used interchangeably herein. In addition, reference to “an element” by the indefinite article “a” or “an” does not exclude the possibility that more than one of the elements is present, unless the context clearly requires that there is one and only one of the elements.

As used herein, “industrially suitable” refers to utilization, and applications, of the achromosomal/anucleated cell-based delivery platform, in contexts outside of internally administered animal host applications, e.g. outside of administered human therapeutics.

The term “a bioactive agent,” (synonymous with “a biologically active agent”) indicates that a composition or compound itself has a biological effect, or that it modifies, causes, promotes, enhances, blocks, reduces, limits the production or activity of, or reacts with or binds to an endogenous molecule that has a biological effect. A “biological effect” may be but is not limited to one that impacts a biological process in/onto a locus; one that impacts a biological process in and/or onto a pest, pathogen or parasite. A bioactive agent may be used in agricultural applications. A biological agent acts to cause or stimulate a desired effect upon a plant, an insect, a worm, bacteria, fungi, or virus. Non-limiting examples of desired effects include, for example, (i) suppressing, inhibiting, limiting, or controlling growth of or killing one or more fungi and their spores, (ii) preventing, treating or curing a disease or condition in a plant suffering from one or more fungi and their spores; (iii) suppressing, inhibiting, limiting, or controlling growth of or killing fungal pathogens that negatively affects a plant; (iv) augmenting the phenotype or genotype of a plant by controlling one or more fungi; (v) stimulating a positive response in one or more plant species, such as desirable plants, to germinate, grow vegetatively, bloom, fertilize, produce fruits and/or seeds, and harvest by controlling one or more fungi; (vi) controlling fungal diseases or disorders.

The terms “control” or “controlling” are meant to include any fungicidal (killing) or fungistatic (inhibiting, maiming or generally interfering) activities of an fungicidal composition against a given pest. Thus, these terms not only include knocking down and killing, but also include such activities of inhibiting or interfering the growth of fungi and their spores.

The term “fungicidally effective amount” is an amount of the compound of the disclosure, or a composition containing the compound, that has an adverse effect (e.g., knockdown and/or death) on at least 1% of the pests treated, at least 5%, at least 10%, at least 15%, at least 20%, at least 25%, at least 30%, at least 35%, at least 40%, at least 45%, at least 50%, at least 60%, at least 70% or greater. An “effective pest-inhibiting amount” is an amount of the compound of the disclosure, or a composition containing the compound, where at least 5%, at least 10%, at least 15%, at least 20%, at least 25% or greater mortality against pests is achieved, at least 30%, at least 35%, at least 40%, at least 45%, at least 50%, at least 60%, at least 70% or greater mortality. Similarly, an “effective pest-growth modulating amount” is one where at least 5%, at least 10%, at least 15%, at least 20%, at least 25% or greater pest-growth modulation is achieved, 50% or greater, 70% at least 30%, at least 35%, at least 40%, at least 45%, at least 50%, at least 60%, at least 70% of greater. The term “amount sufficient to prevent infestation” is also used herein and is intended to mean an amount that is sufficient to deter all but an insignificant sized pest population so that a disease or infected state is prevented.

The term “pest” is defined herein as encompassing vectors of plant, humans or livestock disease, unwanted species of bacteria, fungi, viruses, insects, nematodes mites, ticks or any organism causing harm.

As used herein the terms “cellular organism” “microorganism” or “microbe” should be taken broadly. These terms are used interchangeably and include, but are not limited to, the two prokaryotic domains, Bacteria and Archaea, as well as certain eukaryotic fungi and protists.

The term “encapsulated” means that at least one bioactive agent of the present disclosure is in the interior of the minicell of the present disclosure. In another embodiment, the at least one bioactive agent found on the interior of the minicell of the present disclosure with another compound including, but are not limited to another bioactive agent, an agrochemical, an adjuvant, a carrier, a botanical ingredient, an essential oil and the like.

The term “prokaryotes” is art recognized and refers to cells that contain no nucleus or other cell organelles. The prokaryotes are generally classified in one of two domains, the Bacteria and the Archaea. The definitive difference between organisms of the Archaea and Bacteria domains is based on fundamental differences in the nucleotide base sequence in the 16S ribosomal RNA.

The term “Archaea” refers to a categorization of organisms of the division Mendosicutes, typically found in unusual environments and distinguished from the rest of the prokaryotes by several criteria, including the number of ribosomal proteins and the lack of muramic acid in cell walls. On the basis of ssrRNA analysis, the Archaea consist of two phylogenetically-distinct groups: Crenarchaeota and Euryarchaeota. On the basis of their physiology, the Archaea can be organized into three types: methanogens (prokaryotes that produce methane); extreme halophiles (prokaryotes that live at very high concentrations of salt (NaCl); and extreme (hyper) thermophilus (prokaryotes that live at very high temperatures). Besides the unifying archaeal features that distinguish them from Bacteria (i.e., no murein in cell wall, ester-linked membrane lipids, etc.), these prokaryotes exhibit unique structural or biochemical attributes which adapt them to their particular habitats. The Crenarchaeota consists mainly of hyperthermophilic sulfur-dependent prokaryotes and the Euryarchaeota contains the methanogens and extreme halophiles.

“Bacteria” or “eubacteria” refers to a domain of prokaryotic organisms. Bacteria include at least 11 distinct groups as follows: (1) Gram-positive (gram+) bacteria, of which there are two major subdivisions: (1) high G+C group (Actinomycetes, Mycobacteria, Micrococcus, others) (2) low G+C group (Bacillus, Clostridia, Lactobacillus, Staphylococci, Streptococci, Mycoplasmas); (2) Proteobacteria, e.g., Purple photosynthetic+non-photosynthetic Gram-negative bacteria (includes most “common” Gram-negative bacteria); (3) Cyanobacteria, e.g., oxygenic phototrophs; (4) Spirochetes and related species; (5) Planctomyces; (6) Bacteroides, Flavobacteria; (7) Chlamydia; (8) Green sulfur bacteria; (9) Green non-sulfur bacteria (also anaerobic phototrophs); (10) Radioresistant micrococci and relatives; (11) Thermotoga and Thermosipho thermophiles.

A “eukaryote” is any organism whose cells contain a nucleus and other organelles enclosed within membranes. Eukaryotes belong to the taxon Eukarya or Eukaryota. The defining feature that sets eukaryotic cells apart from prokaryotic cells (the aforementioned Bacteria and Archaea) is that they have membrane-bound organelles, especially the nucleus, which contains the genetic material, and is enclosed by the nuclear envelope.

The terms “genetically modified host cell,” “recombinant host cell,” and “recombinant strain” are used interchangeably herein and refer to host cells that have been genetically modified by the cloning and transformation methods of the present disclosure or known in the art. Thus, the terms include a host cell (e.g., bacteria, yeast cell, fungal cell, CHO, human cell, etc.) that has been genetically altered, modified, or engineered, such that it exhibits an altered, modified, or different genotype and/or phenotype (e.g., when the genetic modification affects coding nucleic acid sequences of the microorganism), as compared to the naturally-occurring organism from which it was derived. It is understood that in some embodiments, the terms refer not only to the particular recombinant host cell in question, but also to the progeny or potential progeny of such a host cell.

The term “wild-type microorganism” or “wild-type host cell” describes a cell that occurs in nature, i.e. a cell that has not been genetically modified. In the disclosure, “wild type strain” or “wild strain” or “wild type cell line” refers to a cell strain/line that can produce minicells. In some embodiments, wild type bacterial strains and/or cell lines such as E. coli strain p678-54 and B. subtilis strain CU403 can make miniature cells deficient in DNA. Methods for producing such minicells are known in the art. See, for example, Adler et al., 1967, Proc. Natl. Acad. Sci. USA 57:321-326; Inselburg J, 1970 1 Bacteriol. 102(3):642-647; Frazer 1975, Curr. Topics Microbiol. Immunol. 69:1-84, Reeve et al 1973, J Bacteriol. 114(2):860-873; and Mendelson et al 1974 1 Bacteriol. 117(3):1312-1319.

The term “genetically engineered” may refer to any manipulation of a host cell's genome (e.g. by insertion, deletion, mutation, or replacement of nucleic acids).

The term “control host cell” refers to an appropriate comparator host cell for determining the effect of a genetic modification or experimental treatment. In some embodiments, the control host cell is a wild type cell. In other embodiments, a control host cell is genetically identical to the genetically modified host cell, save for the genetic modification(s) differentiating the treatment host cell.

As used herein, the term “genetically linked” refers to two or more traits that are co-inherited at a high rate during breeding such that they are difficult to separate through crossing.

A “recombination” or “recombination event” as used herein refers to a chromosomal crossing over or independent assortment.

As used herein, the term “phenotype” refers to the observable characteristics of an individual cell, cell culture, organism, or group of organisms which results from the interaction between that individual's genetic makeup (i.e., genotype) and the environment.

As used herein, the term “chimeric” or “recombinant” when describing a nucleic acid sequence or a protein sequence refers to a nucleic acid, or a protein sequence, that links at least two heterologous polynucleotides, or two heterologous polypeptides, into a single macromolecule, or that rearranges one or more elements of at least one natural nucleic acid or protein sequence. For example, the term “recombinant” can refer to an artificial combination of two otherwise separated segments of sequence, e.g., by chemical synthesis or by the manipulation of isolated segments of nucleic acids by genetic engineering techniques.

As used herein, a “synthetic nucleotide sequence” or “synthetic polynucleotide sequence” is a nucleotide sequence that is not known to occur in nature or that is not naturally occurring. Generally, such a synthetic nucleotide sequence will comprise at least one nucleotide difference when compared to any other naturally occurring nucleotide sequence.

As used herein, a “synthetic amino acid sequence” or “synthetic peptide” or “synthetic protein” is an amino acid sequence that is not known to occur in nature or that is not naturally occurring. Generally, such a synthetic protein sequence will comprise at least one amino acid difference when compared to any other naturally occurring protein sequence.

As used herein, the term “nucleic acid” refers to a polymeric form of nucleotides of any length, either ribonucleotides or deoxyribonucleotides, or analogs thereof. This term refers to the primary structure of the molecule, and thus includes double- and single-stranded DNA, as well as double- and single-stranded RNA. It also includes modified nucleic acids such as methylated and/or capped nucleic acids, nucleic acids containing modified bases, backbone modifications, and the like. The terms “nucleic acid,” “nucleotide,” and “polynucleotide” are used interchangeably.

As used herein, the term “protease-deficient strain” refers to a strain that is deficient in one or more endogenous proteases. For example, protease deficiency can be created by deleting, removing, knock-out, silencing, suppressing, or otherwise downregulating at lease on endogenous protease. Said proteases can include catastrophic proteases. For example, BL21 (DE3) E. coli strain is deficient in proteases Lon and OmpT. E. coli strain has cytoplasmic proteases and membrane proteases that can significantly decrease protein production and localization to the membrane. In some embodiments, a protease-deficient strain can maximize production and localization of a protein of interest to the membrane of the cell. “Protease-deficient” can be interchangeably used as “protease-free” in the present disclosure.

As used herein, the term “gene” refers to any segment of DNA associated with a biological function. Thus, genes include, but are not limited to, coding sequences and/or the regulatory sequences required for their expression. Genes can also include non-expressed DNA segments that, for example, form recognition sequences for other proteins. Genes can be obtained from a variety of sources, including cloning from a source of interest or synthesizing from known or predicted sequence information, and may include sequences designed to have desired parameters.

As used herein, the term “homologous” or “homologue” or “ortholog” is known in the art and refers to related sequences that share a common ancestor or family member and are determined based on the degree of sequence identity. The terms “homology,” “homologous,” “substantially similar” and “corresponding substantially” are used interchangeably herein. They refer to nucleic acid fragments wherein changes in one or more nucleotide bases do not affect the ability of the nucleic acid fragment to mediate gene expression or produce a certain phenotype. These terms also refer to modifications of the nucleic acid fragments of the instant disclosure such as deletion or insertion of one or more nucleotides that do not substantially alter the functional properties of the resulting nucleic acid fragment relative to the initial, unmodified fragment. It is therefore understood, as those skilled in the art will appreciate, that the disclosure encompasses more than the specific exemplary sequences. These terms describe the relationship between a gene found in one species, subspecies, variety, cultivar or strain and the corresponding or equivalent gene in another species, subspecies, variety, cultivar or strain. For purposes of this disclosure homologous sequences are compared. “Homologous sequences” or “homologues” or “orthologs” are thought, believed, or known to be functionally related. A functional relationship may be indicated in any one of a number of ways, including, but not limited to: (a) degree of sequence identity and/or (b) the same or similar biological function. Preferably, both (a) and (b) are indicated. Homology can be determined using software programs readily available in the art, such as those discussed in Current Protocols in Molecular Biology (F.M. Ausubel et al., eds., 1987) Supplement 30, section 7.718, Table 7.71. Some alignment programs are MacVector (Oxford Molecular Ltd, Oxford, U.K.), ALIGN Plus (Scientific and Educational Software, Pennsylvania) and AlignX (Vector NTI, Invitrogen, Carlsbad, CA). Another alignment program is Sequencher (Gene Codes, Ann Arbor, Michigan), using default parameters.

As used herein, the term “endogenous” or “endogenous gene,” refers to the naturally occurring gene, in the location in which it is naturally found within the host cell genome. In the context of the present disclosure, operably linking a heterologous promoter to an endogenous gene means genetically inserting a heterologous promoter sequence in front of an existing gene, in the location where that gene is naturally present. An endogenous gene as described herein can include alleles of naturally occurring genes that have been mutated according to any of the methods of the present disclosure.

As used herein, the term “exogenous” is used interchangeably with the term “heterologous,” and refers to a substance coming from some source other than its native source. For example, the terms “exogenous protein,” or “exogenous gene” refer to a protein or gene from a non-native source or location, and that have been artificially supplied to a biological system.

As used herein, the term “nucleotide change” refers to, e.g., nucleotide substitution, deletion, and/or insertion, as is well understood in the art. For example, mutations contain alterations that produce silent substitutions, additions, or deletions, but do not alter the properties or activities of the encoded protein or how the proteins are made.

As used herein, the term “protein modification” refers to, e.g., amino acid substitution, amino acid modification, deletion, and/or insertion, as is well understood in the art.

As used herein, the term “at least a portion” or “fragment” of a nucleic acid or polypeptide means a portion having the minimal size characteristics of such sequences, or any larger fragment of the full length molecule, up to and including the full length molecule. A fragment of a polynucleotide of the disclosure may encode an enzymatically bioactive portion of a genetic regulatory element. An enzymatically bioactive portion of a genetic regulatory element can be prepared by isolating a portion of one of the polynucleotides of the disclosure that comprises the genetic regulatory element and assessing activity as described herein. Similarly, a portion of a polypeptide may be 4 amino acids, 5 amino acids, 6 amino acids, 7 amino acids, and so on, going up to the full length polypeptide. The length of the portion to be used will depend on the particular application. A portion of a nucleic acid useful as a hybridization probe may be as short as 12 nucleotides; in some embodiments, it is 20 nucleotides. A portion of a polypeptide useful as an epitope may be as short as 4 amino acids. A portion of a polypeptide that performs the function of the full-length polypeptide would generally be longer than 4 amino acids.

Variant polynucleotides also encompass sequences derived from a mutagenic and recombinogenic procedure such as DNA shuffling. Strategies for such DNA shuffling are known in the art. See, for example, Stemmer (1994) PNAS 91:10747-10751; Stemmer (1994) Nature 370:389-391; Crameri et al. (1997) Nature Biotech. 15:436-438; Moore et al. (1997) J. Mol. Biol. 272:336-347; Zhang et al. (1997) PNAS 94:4504-4509; Crameri et al. (1998) Nature 391:288-291; and U.S. Pat. Nos. 5,605,793 and 5,837,458.

For PCR amplifications of the polynucleotides disclosed herein, oligonucleotide primers can be designed for use in PCR reactions to amplify corresponding DNA sequences from cDNA or genomic DNA extracted from any organism of interest. Methods for designing PCR primers and PCR cloning are generally known in the art and are disclosed in Sambrook et al. (2001) Molecular Cloning: A Laboratory Manual (3^{rd} ed., Cold Spring Harbor Laboratory Press, Plainview, New York). See also Innis et al., eds. (1990) PCR Protocols: A Guide to Methods and Applications (Academic Press, New York); Innis and Gelfand, eds. (1995) PCR Strategies (Academic Press, New York); and Innis and Gelfand, eds. (1999) PCR Methods Manual (Academic Press, New York). Known methods of PCR include, but are not limited to, methods using paired primers, nested primers, single specific primers, degenerate primers, gene-specific primers, vector-specific primers, partially-mismatched primers, and the like.

The term “primer” as used herein refers to an oligonucleotide which is capable of annealing to the amplification target allowing a DNA polymerase to attach, thereby serving as a point of initiation of DNA synthesis when placed under conditions in which synthesis of primer extension product is induced, i.e., in the presence of nucleotides and an agent for polymerization such as DNA polymerase and at a suitable temperature and pH. The (amplification) primer is preferably single stranded for maximum efficiency in amplification. Preferably, the primer is an oligodeoxyribonucleotide. The primer must be sufficiently long to prime the synthesis of extension products in the presence of the agent for polymerization. The exact lengths of the primers will depend on many factors, including temperature and composition (A/T vs. G/C content) of primer. A pair of bi-directional primers consists of one forward and one reverse primer as commonly used in the art of DNA amplification such as in PCR amplification.

As used herein, “promoter” refers to a DNA sequence capable of controlling the expression of a coding sequence or functional RNA. In some embodiments, the promoter sequence consists of proximal and more distal upstream elements, the latter elements often referred to as enhancers. Accordingly, an “enhancer” is a DNA sequence that can stimulate promoter activity, and may be an innate element of the promoter or a heterologous element inserted to enhance the level or tissue specificity of a promoter. Promoters may be derived in their entirety from a native gene, or be composed of different elements derived from different promoters found in nature, or even comprise synthetic DNA segments. It is understood by those skilled in the art that different promoters may direct the expression of a gene in different tissues or cell types, or at different stages of development, or in response to different environmental conditions. It is further recognized that since in most cases the exact boundaries of regulatory sequences have not been completely defined, DNA fragments of some variation may have identical promoter activity.

As used herein, the phrases “recombinant construct”, “expression construct”, “chimeric construct”, “construct”, and “recombinant DNA construct” are used interchangeably herein. Also, “construct”, “vector”, and “plasmid” are used interchangeably herein. A recombinant construct comprises an artificial combination of nucleic acid fragments, e.g., regulatory and coding sequences that are not found together in nature. For example, a chimeric construct may comprise regulatory sequences and coding sequences that are derived from different sources, or regulatory sequences and coding sequences derived from the same source, but arranged in a manner different than that found in nature. Such construct may be used by itself or may be used in conjunction with a vector. If a vector is used then the choice of vector is dependent upon the method that will be used to transform host cells. For example, a plasmid vector can be used. The skilled artisan is well aware of the genetic elements that must be present on the vector in order to successfully transform, select and propagate host cells comprising any of the isolated nucleic acid fragments of the disclosure. The skilled artisan will also recognize that different independent transformation events will result in different levels and patterns of expression (Jones et al., (1985) EMBO J. 4:2411-2418; De Almeida et al., (1989) Mol. Gen. Genetics 218:78-86), and thus that multiple events must be screened in order to obtain lines displaying the desired expression level and pattern. Such screening may be accomplished by Southern analysis of DNA, Northern analysis of mRNA expression, immunoblotting analysis of protein expression, or phenotypic analysis, among others. Vectors can be plasmids, viruses, bacteriophages, pro-viruses, phagemids, transposons, artificial chromosomes, and the like, that replicate autonomously or can integrate into a chromosome of a host cell. A vector can also be a naked RNA polynucleotide, a naked DNA polynucleotide, a polynucleotide composed of both DNA and RNA within the same strand, a poly-lysine-conjugated DNA or RNA, a peptide-conjugated DNA or RNA, a liposome-conjugated DNA, or the like, that is not autonomously replicating. As used herein, the term “expression” refers to the production of a functional end-product e.g., an mRNA or a protein (precursor or mature).

“Operably linked” means in this context the sequential arrangement of the promoter polynucleotide according to the disclosure with a further oligo- or polynucleotide, resulting in transcription of said further polynucleotide.

As used herein, the term “display” refers to the exposure of the polypeptide of interest on the outer surface of the minicell. By way of non-limiting example, the displayed polypeptide may be a protein or a protein domain which is either expressed on the minicell membrane or is associated with the minicell membrane such that the extracellular domain or domain of interest is exposed on the outer surface of the minicell (expressed and displayed on the surface of the minicell or expressed in the parental cell to be displayed on the surface of the segregated/budded minicell). In all instances, the “displayed” protein or protein domain is available for interaction with extracellular components. A membrane-associated protein may have more than one extracellular domain, and a minicell of the disclosure may display more than one membrane-associated protein.

As used herein, the terms “polypeptide”, “protein” and “protein domain” refer to a macromolecule made up of a single chain of amino acids joined by peptide bonds. Polypeptides of the disclosure may comprise naturally occurring amino acids, synthetic amino acids, genetically encoded amino acids, non-genetically encoded amino acids, and combinations thereof. Polypeptides may include both L-form and D-form amino acids.

As used herein, the term “enzymatically bioactive polypeptide” refers to a polypeptide which encodes an enzymatically functional protein. The term “enzymatically bioactive polypeptide” includes but not limited to fusion proteins which perform a biological function. Exemplary enzymatically bioactive polypeptides, include but not limited to enzymes/enzyme moiety (e.g. wild type, variants, or engineered variants) that specifically bind to certain receptors or biological/chemical substrates to effect a biological function such as biological signal transduction or chemical inactivation.

As used herein, the term “ribonuclease-deficient strain” refers to a strain that is deficient in one or more endogenous ribonuclease. For example, ribonuclease deficiency can be created by deleting, removing, knock-out, silencing, suppressing, or otherwise downregulating at lease on endogenous ribonuclease. Said ribonuclease can include ribonuclease III. For example, HT115 E. coli strain is deficient in RNase III. In some embodiments, a ribonuclease-deficient strain is unable to and/or has a reduced capability of recognizing dsRNA and cleaving it at specific targeted locations. “Ribonuclease-deficient” can be interchangeably used as “ribonuclease-free” in the present disclosure. In some embodiments, the ribonuclease-deficient strain can be used to make minicells of the present disclosure.

As used herein, the term “anucleated cell” refers to a cell that lacks a nucleus and also lacks chromosomal DNA and which can also be termed as an “anucleate cell”. Because eubacterial and archaebacterial cells, unlike eukaryotic cells, naturally do not have a nucleus (a distinct organelle that contains chromosomes), these non-eukaryotic cells are of course more accurately described as being “without chromosomes” or “achromosomal.” Nonetheless, those skilled in the art often use the term “anucleated” when referring to bacterial minicells in addition to other eukaryotic minicells. Accordingly, in the present disclosure, the term “minicells” encompasses derivatives of eubacterial cells that lack a chromosome; derivatives of archaebacterial cells that lack their chromosome(s), and anucleate derivatives of eukaryotic cells that lack a nucleus and consequently a chromosome. Thus, in the present disclosure, “anucleated cell” or “anucleate cell” can be interchangeably used with the term “achromosomal cell.”

As used herein, the term “binding site,” means a molecular structure or compound, such as a protein, a polypeptide, a polysaccharide, a glycoprotein, a lipoprotein, a fatty acid, a lipid or a nucleic acid or a particular region in such molecular structure or compound or a particular conformation of such molecular structure or compound, or a combination or complex of such molecular structures or compounds. In certain embodiments, at least one binding site is on an intact living plant. An “intact living plant,” as used herein, means a plant as it grows, whether it grows in soil, in water or in artificial substrate, and whether it grows in the field, in a greenhouse, in a yard, in a garden, in a pot or in hydroponic culture systems. An intact living plant preferably comprises all plant parts (roots, stem, branches, leaves, needles, thorns, flowers, seeds etc.) that are normally present on such plant in nature, although some plant parts, such as, e.g., flowers, may be absent during certain periods in the plant's life cycle.

A “binding domain,” as used herein, means the whole or part of a proteinaceous (protein, protein-like or protein containing) molecule that is capable of binding using specific intermolecular interactions to a target molecule. A binding domain can be a naturally occurring molecule, it can be derived from a naturally occurring molecule, or it can be entirely artificially designed. A binding domain can be based on domains present in proteins, including but not limited to microbial proteins, protease inhibitors, toxins, fibronectin, lipocalins, single-chain antiparallel coiled coil proteins or repeat motif proteins. Non-limiting examples of such binding domains are carbohydrate binding modules (CBM) such as cellulose binding domain to be targeted to a locus. In some embodiments, a cell adhesion moiety comprises a binding domain.

As used herein, “carrier,” “acceptable carrier,” or “biologically actively acceptable carrier” refers to a diluent, adjuvant, excipient, or vehicle with which a composition can be administered to its target, which does not detrimentally effect the composition.

As used herein, “plant part” can refer to any portion of a growing plant, including the roots, stems, stalks, leaves, branches, seeds, flowers, fruits, and the like. For example, cinnamon essential oil can be derived from the leaves or bark of a cinnamon plant.

As used herein, the term “essential oils” refers to aromatic, volatile liquids extracted from plant material. Essential oils are often concentrated hydrophobic liquids containing volatile aroma compounds. Essential oil chemical constituents can fall within general classes, such as terpenes (e.g., p-Cymene, limonene, sabinene, a-pinene, y-terpinene, b-caryophyllene), terpenoids (e.g., geraniol, citronellal, thymol, carvacrol, carvone, borneol) and phenylpropanoids (e.g., cinnamaldehyde, eugenol, vanillin, safrole). Essential oils can be natural (i.e., derived from plants), or synthetic.

As used herein, the term “essential oil” encompasses within the scope of the present disclosure also botanical oils and lipids. Non-limiting examples of essential oils are sesame oil, pyrethrum (extract), glycerol-derived lipids or glycerol fatty acid derivatives, cinnamon oil, cedar oil, clove oil, geranium oil, lemongrass oil, angelica oil, mint oil, turmeric oil, wintergreen oil, rosemary oil, anise oil, cardamom oil, caraway oil, chamomile oil, coriander oil, guaiacwood oil, cumin oil, dill oil, mint oil, parsley oil, basil oil, camphor oil, cananga oil, citronella oil, eucalyptus oil, fennel oil, ginger oil, copaiba balsam oil, perilla oil, cedarwood oil, jasmine oil, palmarosa sofia oil, western mint oil, star anis oil, tuberose oil, neroli oil, tolu balsam oil, patchouli oil, palmarosa oil, Chamaecyparis obtusa oil, Hiba oil, sandalwood oil, petitgrain oil, bay oil, vetivert oil, bergamot oil, Peru balsam oil, bois de rose oil, grapefruit oil, lemon oil, mandarin oil, orange oil, oregano oil, lavender oil, Lindera oil, pine needle oil, pepper oil, rose oil, iris oil, sweet orange oil, tangerine oil, tea tree oil, tea seed oil, thyme oil, thymol oil, garlic oil, peppermint oil, onion oil, linaloe oil, Japanese mint oil, spearmint oil, ajowan oil, giant knotweed extract, and others as disclosed herein throughout.

As used herein, the term “stabilize” or “stabilizing” when used with respect to a bioactive agent, a bioactive ingredients, a composition, a compound, or a formulation refers to prevention of chemical or biological degradation of the bioactive agent in thermal or pH change. In some embodiments, “stabilize” or “stabilizing” includes prevention of pH-driven chemical degradation of a bioactive agent and prevention of temperature-driven degradation of a bioactive agent. In further embodiments, “stabilize” or “stabilizing” includes prevention against oxidative stress/oxidation, hydrolysis, and any other form of chemical degradation.

The term “bioavailability” includes, generally, the degree to which a bioactive agent, a bioactive ingredient, a drug or other substance becomes available to a target subject after delivery, application or administration. In some embodiments, the term “bioavailability” refers to effective dose of a bioactive agent that reaches intended target, locus or subject.

The term “depletion flocculation” refers to that depletion forces destabilize colloids and bring the dispersed particles together resulting in flocculation. The particles are no longer dispersed in the liquid but concentrated in floc formations. In some embodiments, a bioactive agent taught herein is preserved from depletion flocculation in acidic condition by minicells taught herein.

The preset disclosure provides a novel minicell platform using AgriCell technology, which is a highly modular and tunable biological microcapsule that can encapsulate, stabilize, and effectively deliver a sustained release of a bioactive ingredients with fungicidal activity to control fungi or fungal-like microorganisms. The key to the AgriCell technology is that it harnesses the capabilities of synthetic biology to produce a bioencapsulation technology that is environmentally compatible, modular in its functionality, and scalable for agricultural applications. Bioactive, non-pathogenic microbial cells are engineered to produce a bioparticle through asymmetric cell division. These bioparticles are small (about less than 1 μm in diameter), spherical versions of their parent microbial cells and they maintain the properties of the parent cell with one major difference: they lack chromosomal DNA. Therefore, the biological particles retain the benefits of the parent microbe, but do not risk contaminating the environment with modified DNA or outcompeting native species since they do not propagate.

Also, the present disclosure a novel minicell platform using AgriCell technology, which represents a potential platform which not only acts as potent candidate delivery systems but also provide a tool for efficient antifungal systems.

In some embodiments, the minicells taught herein are naturally occurring anucleate cells.

In other embodiments, the present disclose teaches novel minicells that are engineered to encapsulate high-payload capacities of bioactive ingredients for controlling, suppressing or preventing growth of fungi and spores, or killing them. Also, the robustness of minicell production is improved.

The present disclosure teaches that microencapsulation of biologically active agents/ingredients into AgriCell has two functions: (1) to enhance thermo stability, photo stability, shelf-life, and biological activity of biofungicides including the essential oils; and (2) to ensure targeted delivery of biofungicides to a target. The present disclosure teaches to overcome imitations of bioactive agents, especially essential oils, as biofungicides such as (i) Essential Oils (EOs) affected by environmental conditions (light, temperature, or moisture); (ii) high reactivity and volatility; (iii) interaction with other matrices; (iv) low bioavailability and stability, or (v) strong odor and taste.

The present disclosure further provides that the AgriCell as minicells taught herein, serves as a carrier that protects bioactive agents/ingredients from environmental stresses until it delivers its high-payload capacity slowly to a target through the natural breakdown of its biodegradable membrane. This minicell-encapsulation technology overcomes many of the problems of bioactive agent delivery and can serve as the much-needed replacement to traditional techniques using plastic microcapsules.

In some embodiments, the AgriCell technology can be engineered in various ways to improve stability of bioactive agents (such as essential oils) encapsulated into the AgriCell and provide tailored controlled release profiles of the bioactive agents.

In other embodiments, the AgriCell technology can also be genetically engineered in various ways to enhance/improve bioavailability or sustainability of biofungicides or maintain fungicidal activity of biofungicides in an extended or controlled manner. The advantages of AgriCell platform include the simplicity of the production method, and safety.

The present disclosure teaches successful encapsulation of different bioactive ingredients of interest into minicells as the AgriCell platform for applications of plant pathogenic fungi control, shows outstanding biological activity, improved stability and controlled release.

In some embodiments, the bioactive ingredients successfully encapsulated by the AgriCell platform indicate its biological effect and common drawbacks of unencapsulated bioactive ingredients overcome by AgriCell encapsulation.

### Minicells

Minicells are the result of aberrant, asymmetric cell division, and contain membranes, peptidoglycan, ribosomes, RNA, protein, and often plasmids but no chromosome. (Frazer AC and Curtiss III, Production, Properties and Utility of Bacterial Minicells, Curr. Top. Microbial. Immunol. 69:1-84 (1975)). Because minicells lack chromosomal DNA, minicells cannot divide or grow, but they can continue other cellular processes, such as ATP synthesis, replication and transcription of plasmid DNA, and translation of mRNA. Although chromosomes do not segregate into minicells, extrachromosomal and/or episomal genetic expression elements may segregate, or may be introduced into minicells after segregation from parent cells.

In some embodiments, the minicells described herein are naturally occurring.

In other embodiments, the minicells described herein are non-naturally occurring.

In some embodiments, the disclosure provides a composition comprising a plurality of minicells. In some embodiments, the disclosure provides a composition comprising a plurality of minicells comprising at least one biologically active compound within said cell. In some embodiments, the disclosure provides a composition comprising a plurality of minicells, each minicell of said plurality comprises an enzymatically bioactive polypeptide displayed on the surface of the minicell, said enzymatically bioactive polypeptide has enzymatic activity. The enzymatic activity is derived from enzymatically bioactive polypeptides disclosed in the present disclosure.

In some embodiments, the disclosure provides a composition comprising a plurality of intact, bacterially-derived minicells. In some embodiments, the disclosure provides a composition comprising a plurality of intact, bacterially-derived minicells comprising at least one biologically active compound within said cell. In some embodiments, the disclosure provides a composition comprising a plurality of intact, bacterially-derived minicells, each minicell of said plurality comprises an enzymatically bioactive polypeptide displayed on the surface of the bacterial minicell, said enzymatically bioactive polypeptide has enzymatic activity. In some embodiments, the composition comprises minicells which further comprise a second polypeptide displayed on the surface of the bacterial minicell, to increase adhesion to a subject and/or subjects including, but are not limited to substrates of enzymes, receptors, metal, plastic, soil, bacteria, fungi, pathogens, germs, insects, plants, animals, human, and the like. In some embodiments, the composition comprises a mixture of minicells, certain minicells within the mixed minicell population display the enzymatically bioactive polypeptide or display the second polypeptide including subject adhesion increasing polypeptide or display both.

The term “minicell” in this disclosure refers to the result of aberrant, asymmetric cell division, and contain membranes, peptidoglycan, ribosomes, RNA, protein, and often plasmids but no chromosome. Because minicells lack chromosomal DNA, minicells cannot divide or grow, but they can continue other cellular processes, such as ATP synthesis, replication and transcription of plasmid DNA, and translation of mRNA. Although chromosomes do not segregate into minicells, extrachromosomal and/or episomal genetic expression elements may segregate or may be introduced into minicells after segregation from parent cells. In some embodiments, the minicells described herein are naturally occurring. In other embodiments, the minicells described herein are non-naturally occurring. In some embodiments, minicells can be loaded with the biologically active agents described herein.

Minicells are derivatives of cells that lack chromosomal DNA and which are sometimes referred to as anucleate cells. Because eubacterial and archeabacterial cells, unlike eukaryotic cells, do not have a nucleus (a distinct organelle that contains chromosomes), these non-eukaryotic minicells are more accurately described as being “without chromosomes” or “achromosomal,” as opposed to “anucleate.” Nonetheless, those skilled in the art often use the term “anucleate” when referring to bacterial minicells in addition to other minicells. Accordingly, in the present disclosure, the term “minicells” encompasses derivatives of eubacterial cells that lack a chromosome; derivatives of archeabacterial cells that lack their chromosome(s), and anucleate derivatives of eukaryotic cells.

A description of minicells and methods of making and using such minicells can be found, for example, in International Patent application Nos. WO2018/201160, WO2018/201161, WO2019/060903, and WO2021/133846, all of which are incorporated herein by reference.

### Eubacterial Minicells

One type of minicell is a eubacterial minicell. For reviews of eubacterial cell cycle and division processes, see Rothfield et al., Annu. Rev. Genet., 33:423-48, 1999; Jacobs et al., Proc. Natl. Acad. Sci. USA, 96:5891-5893, May, 1999; Koch, Appl. and Envir. Microb., Vol. 66, No. 9, pp. 3657-3663; Bouche and Pichoff, Mol Microbiol, 1998. 29: 19-26; Khachatourians et al., J Bacteriol, 1973. 116: 226-229; Cooper, Res Microbiol, 1990. 141: 17-29; and Danachie and Robinson, “Cell Division: Parameter Values and the Process,” in: Escherichia Coli and Salmonella Typhimurium: Cellular and Molecular Biology, Neidhardt, Frederick C., Editor in Chief, American Society for Microbiology, Washington, D.C., 1987, Volume 2, pages 1578-1592, and references cited therein; and Lutkenhaus et al., “Cell Division,” Chapter 101 in: Escherichia coli and Salmonella typhimurium: Cellular and Molecular Biology, 2^{nd} Ed., Neidhardt, Frederick C., Editor in Chief, American Society for Microbiology, Washington, D.C., 1996, Volume 2, pages 1615-1626, and references cited therein. When DNA replication and/or chromosomal partitioning is altered, membrane-bounded vesicles “pinch off” from parent cells before transfer of chromosomal DNA is completed. As a result of this type of dysfunctional division, minicells are produced which contain an intact outer membrane, inner membrane, cell wall, and all of the cytoplasm components but do not contain chromosomal DNA.

In some embodiments, the bacterially-derived minicells are produced from a strain, including, but are not limited to a strain of Escherichia coli, Bacillus spp., Salmonella spp., Listeria spp., Mycobacterium spp., Shigella spp., or Yersinia spp. In some embodiments, the bacterially-derived minicells are produced from a strain that naturally produces minicells. Such natural minicell producing strains produce minicells, for example, at a 2:1 ratio (2 bacterial cells for every one minicell). In certain embodiments, exemplary bacterial strains that naturally produce minicells include, but are not limited to E. coli strain number P678-54, Coli Genetic Stock Center (CGSC) number: 4928 and B. subtilis strain CU403.

As one example, mutations in B. subtilis smc genes result in the production of minicells (Britton et al., 1998, Genes andDev. 12:1254-1259; Moriya et al., 1998, Mol Microbiol 29:179-87). Disruption of smc genes in various cells is predicted to result in minicell production therefrom.

As another example, mutations in the divIVA gene of Bacillus subtilis results in minicell production. When expressed in E. coli, B. subtilis or yeast Schizosaccharomyces pombe, a DivIVA-GFP protein is targeted to cell division sites therein, even though clear homologs of DivIVA do not seem to exist in E. coli, B. subtilis or S. pombe (David et al., 2000, EMBO J. 19:2719-2727. Over- or under-expression of B. subtilis DivIVA or a homolog thereof may be used to reduce minicell production in a variety of cells.

In some embodiments, the minicell-producing bacteria is a Gram-negative bacteria. The Gram-negative bacteria includes, but is not limited to, Escherichia coli, Salmonella spp. including Salmonella typhimurium, Shigella spp. including Shigella flexneri, Pseudomonas aeruginosa, Agrobacterium, Campylobacter jejuni, Lactobacillus spp., Neisseria gonorrhoeae, and Legionella pneumophila,. In some embodiments, the minicell-producing gram-negative bacteria can produce minicells naturally caused by endogenous or exogenous mutation(s) associated with cell division and/or chromosomal partitioning. In some embodiments, the minicell-producing bacteria comprises endogenous or exogenous gene(s) that is involved in cell division and/or chromosomal partitioning, where the gene is genetically modified such as by homologous recombination, compared to a corresponding wild-type gene. In some embodiments, the minicell-producing gram-negative bacteria is deficient in protease and/or its activity naturally and/or by genetic engineering techniques disclosed herein. In some embodiments, the protease-deficient minicell-producing gram-negative bacteria comprises a recombinant expression vector comprising a gene or genes that is involved in a protein of interest disclosed in the present disclosure.

In some embodiments, the minicell-producing bacteria can be a Gram-positive bacteria. The Gram-positive bacteria includes, but is not limited to, Bacillus subtilis, Bacillus cereus, Corynebacterium Glutamicum, Lactobacillus acidophilus, Staphylococcus spp., or Streptococcus spp. In some embodiments, the minicell-producing gram-positive bacteria can produce minicells naturally caused by endogenous or exogenous mutation(s) associated with cell division and/or chromosomal partitioning. In some embodiments, the minicell-producing gram-positive bacteria comprises endogenous or exogenous gene(s) that is involved in cell division and/or chromosomal partitioning, where the gene is genetically modified such as by homologous recombination, compared to a corresponding wild-type gene. In some embodiments, the minicell-producing gram-positive bacteria is deficient in protease and/or its activity naturally and/or by genetic engineering techniques disclosed herein. In some embodiments, the protease-deficient minicell-producing gram-positive bacteria comprises a recombinant expression vector comprising a gene or genes that is involved in a protein of interest disclosed in the present disclosure.

The minicell-producing bacteria can be a Extremophilic bacteria. The Extremophilic bacteria includes, but is not limited to, Thermophiles including Thermus aquaticus, Psychrophiles, Piezophiles, Halophilic bacteria, Acidophile, Alkaliphile, Anaerobe, Lithoautotroph, Oligotroph, Metallotolerant, Oligotroph, Xerophil or Polyextremophile. In some embodiments, the minicell-producing Extremophilic bacteria can produce minicells naturally caused by endogenous or exogenous mutation(s) associated with cell division and/or chromosomal partitioning. In some embodiments, the minicell-producing Extremophilic bacteria comprises endogenous or exogenous gene(s) that is involved in cell division and/or chromosomal partitioning, where the gene is genetically modified such as by homologous recombination, compared to a corresponding wild-type gene. In some embodiments, the minicell-producing Extremophilic bacteria is deficient in protease and/or its activity naturally and/or by genetic engineering techniques disclosed herein. In some embodiments, the protease-deficient minicell-producing Extremophilic bacteria comprises a recombinant expression vector comprising a gene or genes that is involved in a protein of interest disclosed in the present disclosure.

### Eukaryotic Minicells

Achromosomal eukaryotic minicells (i.e., anucleate cells) are within the scope of the disclosure. Yeast cells are used to generate fungal minicells. See, e.g., Lee et al., Ibdlp, a possible spindle pole body associated protein, regulates nuclear division and bud separation in Saccharomyces cerevisiae, Biochim Biophys Acta 3:239-253, 1999; Kopecka et al., A method of isolating anucleate yeast protoplasts unable to synthesize the glucan fibrillar component of the wall J Gen Microbiol 81:111-120, 1974; and Yoo et al., Fission yeast Hrpl, a chromodomain ATPase, is required for proper chromosome segregation and its overexpression interferes with chromatin condensation, Nucl Acids Res 28:2004-2011, 2000. Cell division in yeast is reviewed by Gould and Simanis, The control of septum formation in fission yeast, Genes & Dev 11:2939-51, 1997).

In some embodiments, the eukaryotic minicells can be produced from yeast cells, such as Saccharomyces cerevisiae, Pichia pastoris and/or Schizosaccharomyces pombe.

As one example, mutations in the yeast genes encoding TRF topoisomerases result in the production of minicells, and a human homolog of yeast TRF genes has been stated to exist (Castano et al., 1996, Nucleic Acids Res 24:2404-10). Mutations in a yeast chromodomain ATPase, Hrpl, result in abnormal chromosomal segregation; (Yoo et al., 2000 Nuc. Acids Res. 28:2004-2011). Disruption of TRF and/or Hrp 1 function is predicted to cause minicell production in various cells. Genes involved in septum formation in fission yeast (see, e.g., Gould et al., 1997 Genes and Dev. 11:2939-2951) can be used in like fashion.

Platelets are a non-limiting example of eukaryotic minicells. Platelets are anucleate cells with little or no capacity for de novo protein synthesis. The tight regulation of protein synthesis in platelets (Smith et al., 1999, Vasc Med 4:165-72) may allow for the over-production of exogenous proteins and, at the same time, under-production of endogenous proteins. Thrombin-activated expression elements such as those that are associated with Bc1-3 (Weyrich et al., Signal-dependent translation of a regulatory protein, Bc1-3, in activated human platelets, Cel Biology 95:5556-5561, 1998) may be used to modulate the expresion of exogneous genes in platelets.

As another non-limiting example, eukaryotic minicells are generated from tumor cell lines (Gyongyossy-Issa and Khachatourians, Tumour minicells: single, large vesicles released from cultured mastocytoma cells (1985) Tissue Cell 17:801-809; Melton, Cell fusion-induced mouse neuroblastomas HPRT revertants with variant enzyme and elevated HPRT protein levels (1981) Somatic Cell Genet. 7: 331-344).

Yeast cells are used to generate fungal minicells. See, e.g., Lee et al., Ibdlp, a possible spindle pole body associated protein, regulates nuclear division and bud separation in Saccharomyces cerevisiae, Biochim Biophys Acta 3:239-253, 1999; Kopecka et al., A method of isolating anucleate yeast protoplasts unable to synthesize the glucan fibrillar component of the wall J Gen Microbiol 81:111-120, 1974; and Yoo et al., Fission yeast Hrp 1, a chromodomain ATPase, is required for proper chromosome segregation and its overexpression interferes with chromatin condensation, Nucl Acids Res 28:2004-2011, 2000. Cell division in yeast is reviewed by Gould and Simanis, The control of septum formation in fission yeast, Genes & Dev 11:2939-51, 1997). In some embodiments, the present disclosure teaches production of yeast minicells.

### Archaebacterial Minicells

The term “archaebacterium” is defined as is used in the art and includes extreme thermophiles and other Archaea (Woese, C.R., L. Magrum. G. Fox. 1978. Archaebacteria. Journal of Molecular Evolution. 11:245-252). Three types of Archaebacteria are halophiles, thermophiles and methanogens. By physiological definition, the Archaea (informally, archaes) are single-cell extreme thermophiles (including thermoacidophiles), sulfate reducers, methanogens, and extreme halophiles. The thermophilic members of the Archaea include the most thermophilic organisms cultivated in the laboratory. The aerobic thermophiles are also acidophilic; they oxidize sulfur in their environment to sulfuric acid. The extreme halophiles are aerobic or microaerophilic and include the most salt tolerant organisms known. The sulfate-reducing Archaea reduce sulfate to sulfide in extreme environment. Methanogens are strict anaerobes, yet they gave rise to at least two separate aerobic groups: the halophiles and a thermoacidophilic lineage. Non-limiting examples of halophiles include Halobacterium cutirubrum and Halogerax mediterranei. Non-limiting examples of methanogens include Methanococcus voltae; Methanococcus vanniela; Methanobacterium thermoautotrophicum; Methanococcus voltae; Methanothermus fervidus; and Methanosarcina barkeri. Non-limiting examples of thermophiles include Azotobacter vinelandii; Thermoplasma acidophilum; Pyrococcus horikoshii; Pyrococcus furiosus; and Crenarchaeota (extremely thermophilic archaebacteria) species such as Sulfolobus solfataricus and Sulfolobus acidocaldarius.

Archaebacterial minicells are within the scope of the disclosure. Archaebacteria have homologs of eubacterial minicell genes and proteins, such as the MinD polypeptide from Pyrococcus furiosus (Hayashi et al., EMBO 1 20:1819-28, 2001). It is thus possible to create Archaebacterial minicells by methods such as, by way of non-limiting example, overexpressing the product of a min gene isolated from a prokaryote or an archaebacterium; or by disrupting expression of a min gene in an archaebacterium of interest by, e.g., the introduction of mutations thereof or anti sense molecules thereto. See, e.g., Laurence et al., Genetics 152:1315-1323, 1999.

By physiological definition, the Archaea (informally, archaes) are single-cell extreme thermophiles (including thermoacidophiles), sulfate reducers, methanogens, and extreme halophiles. The thermophilic members of the Archaea include the most thermophilic organisms cultivated in the laboratory. The aerobic thermophiles are also acidophilic; they oxidize sulfur in their environment to sulfuric acid. The extreme halophiles are aerobic or microaerophilic and include the most salt tolerant organisms known. The sulfate-reducing Archaea reduce sulfate to sulfide in extreme environment. Methanogens are strict anaerobes, yet they gave rise to at least two separate aerobic groups: the halophiles and a thermoacidophilic lineage. In some embodiments, the present disclosure teaches production of archaeal minicells.

Minicells Derived from Endophytes

An endophyte is an endosymbiont, often a bacterium or fungus, that lives within a plant for at least part of its life cycle. The endophyte can transport itself from the environment to internal organs of plants. Non-limiting examples of endophytes include Acidovorax facilis, Bradyrhizobium, Rhizobium, Rhodococcus rhodochrous, Colletotrichum, Curvularia, Epichloe, Fusarium, Mycosphaerella, Neotyphodium, Piriformospora, and Serendipita. In some embodiments, the present disclosure teaches production of endophyte-derived minicells. In other embodiments, endophyte-derived minicells can enter into internal plant cell, tissues, or organs, and function as an invasive minicell.

Fungal endophytes have the ability to colonize inter- or intra-cellularly. The colonization process involves several steps, including host recognition, spore germination, penetration of the epidermis and tissue multiplication. Once the endophytes are successfully colonized in the host tissue, the endophytic niche becomes established. In the endophytic niche, endophytes will obtain a reliable source of nutrition from the plant fragment, exudates and leachates and protect the host against other microorganisms (Gao et al., 2010). In some embodiments, minicells produced from fungal endophytes can transmit the bioactive compounds within and/or on their surface to a target using their invasive capability.

Minicells Derived from Plant Pathogen Bacteria

The present disclosure provides plant pathogen bacteria, which can be utilized for minicell production, including but are not limited to (1) Pseudomonas syringae pathovars; (2) Ralstonia solanacearum; (3) Agrobacterium tumefaciens; (4) Xanthomonas oryzae pv. oryzae; (5) Xanthomonas campestrispathovars; (6) Xanthomonas axonopodis pathovars; (7) Erwinia amylovora; (8) Xylella fastidiosa; (9) Dickeya (dadantii and solani); (10) Pectobacterium carotovorum (and Pectobacterium atrosepticum), (11) Clavibacter michiganensis (michiganensis and sepedonicus), (12) Pseudomonas savastanoi, and (13) Candidatus Liberibacter asiaticus. Such plant pathogen bacteria natively have the capacity to penetrate and invade into internal host tissues in their natural state. In some embodiments, minicells derived from plant pathogen bacteria described above can naturally deliver biologically active compounds disclosed herein into internal cells, tissues, and/or organs of a target host in their natural ability of invasion, penetration, and/or transmission into internal parts of a target.

From example, some pathogen bacteria are found to secrete cell wall-degrading endoglucanase and endopolygalacturonase, potentially explaining penetration into the root endosphere. Other pathogen bacteria can penetrate through the stomata into the substomatal chamber, and colonization of the intercellular spaces of the leaf mesophyll. The minicells produced from these pathogen bacteria possess and utilize natural ability of invading, penetrating and/or transmitting for scalable and targeted delivery of bioactive compounds disclosed herein.

### Bacterial Minicell Production

Minicells are produced by parent cells having a mutation in, and/or overexpressing, or under expressing a gene involved in cell division and/or chromosomal partitioning, or from parent cells that have been exposed to certain conditions, that result in aberrant fission of bacterial cells and/or partitioning in abnormal chromosomal segregation during cellular fission (division). The term “parent cells” or “parental cells” refers to the cells from which minicells are produced. Minicells, most of which lack chromosomal DNA (Mulder et al., Mol Gen Genet, 221: 87-93, 1990), are generally, but need not be, smaller than their parent cells. Typically, minicells produced from E. coli cells are generally spherical in shape and are about 0.1 to about 0.3 μm in diameter, whereas whole E. coli cells are about from about 1 to about 3 μm in diameter and from about 2 to about 10 μm in length. Micrographs of E. coli cells and minicells that have been stained with DAPI (4:6-diamidino-z-phenylindole), a compound that binds to DNA, show that the minicells do not stain while the parent E. coli are brightly stained. Such micrographs demonstrate the lack of chromosomal DNA in minicells. (Mulder et al., Mol. Gen. Genet. 221:87-93, 1990).

Minicells are achromosomal, membrane-encapsulated biological microparticles (≤1 p.m) that are formed by bacteria following a disruption in the normal division apparatus of bacterial cells. In essence, minicells are small, metabolically bioactive replicas of normal bacterial cells with the exception that they contain no chromosomal DNA and as such, are non-dividing and non-viable. Although minicells do not contain chromosomal DNA, the ability of plasmids, RNA, native and/or recombinantly expressed proteins, and other metabolites have all been shown to segregate into minicells. Some methods of construction of minicell-producing bacterial strains are discussed in detail in U.S. patent application Ser. No. 10/154,951(US Publication No. US/2003/0194798 A1), which is hereby incorporated by reference in its entirety.

Disruptions in the coordination between chromosome replication and cell division lead to minicell formation from the polar region of most rod-shaped prokaryotes. Disruption of the coordination between chromosome replication and cell division can be facilitated through the overexpression of some of the genes involved in septum formation and binary fission. Alternatively, minicells can be produced in strains that harbor mutations in genes that modulate septum formation and binary fission. Impaired chromosome segregation mechanisms can also lead to minicell formation as has been shown in many different prokaryotes.

A description of methods of making, producing, and purifying bacterial minicells can be found, for example, in International Patent application No. WO2018/201160, WO2018/201161, WO2019/060903, and WO2021/133846, which are incorporated herein by reference.

Also, a description of strains for producing minicells an be found, for example, in International Patent application No. WO2019/060903, and WO2021/133846, which are incorporated herein by reference.

In some embodiments, the present disclosure teaches a composition comprising: a minicell and a bioactive agent. In some embodiments, the minicell is derived from a bacterial cell. In some embodiments, the minicell is less than or equal to 1 μm in diameter. The minicell is about 10 nm-about 1000 nm in size, about 20 nm-about 990 nm in size, about 30 nm-about 980 nm in size, about 50 nm-about 950 nm in size, about 100 nm-about 900 nm in size, about 150 nm-about 850 nm in size, about 200 nm-about 800 nm in size, or about 30 nm-about 700 nm in size.

### Biologically Active Compounds

The present disclosure provides biologically active compounds for controlling one or more fungi, as well as a minicell-based platform and/or an agricultural formulation for the encapsulation and delivery of biologically active compounds to a target, locus, or subject. In some embodiments, the minicell-based platform and/or an agricultural formulation comprises an intact minicell, which comprises at least one biologically active compounds. By way of non-limiting example, the biologically active compound is biofungicides including, but are not limited to, essential oils, botanical ingredients, saponins, and combinations thereof. There is currently great interest in the agricultural industry to begin replacing some of these synthetic compounds with their biologically derived counterparts. In some embodiments, the biologically active compound is a biofungicide.

In some embodiments, the present disclose teaches a composition comprising: a minicell and a bioactive agent with fungicidal activity. The bioactive agent is encapsulated by the minicell. The bioactive agent is a biologically active agent. In some embodiments, the biologically active agent is an essential oil. In some embodiments, said essential oil comprises thymol, geraniol, or eugenol

### Essential Oils

Essential oils (EOs) and plant extracts represent a major group of phytobiotics, consisting of a complex mixture of different volatile and non-volatile compounds. Due to their strong aromatic features and bioactivity, EOs have been widely used since ancient times in aromatherapy, as flavor and fragrances in cosmetics and foods, and more recently as pharmaceuticals, natural preservatives, additives, and biofungicides. The bioactivity of EOs depends on their complex mixture of volatile molecules produced by the secondary metabolism of aromatic and medical plants. Terpenoids are known as a major class of EOs components. Among natural compounds, the terpenoids are the largest family of plant secondary metabolites, with over 40,000 different chemical structures described to date. Factors that influence the bioactivity of EOs, regardless of the field of application, are related to plant species, growing conditions, harvest time, and plant chemotype, among others. Due to the volatile and reactive nature of EOs, their effectiveness in the field can be influenced by different conditions during production processes, storage of EOs, and environmental conditions.

“Essential oil” is a concentrated hydrophobic liquid containing volatile aroma compounds from plants. Essential oils may contain a single component, or one or more major components together with one or more minor constituents. Essential oils within the context of the present disclosure include essential oils comprising mixtures of different constituents as well as essential oils which are enriched for one or more constituents or contain substantially a single essential oil constituent. Essential oils include essential oils, and constituents thereof, which are isolated from natural sources (e.g., plants) and/or prepared synthetically.

Essential oils are complex mixtures of natural molecules which are fundamentally obtained from plants. They are secondary metabolites which can normally be obtained by extraction with organic solvents and subsequent concentration, or by physical treatments with steam followed by separation of the water-insoluble phase. Generally they are volatile liquids soluble in organic solvents and have a density lower than that of water.

In nature they can be synthesised in different plant organs such as seeds, leaves, flowers, epidermal cells and fruits, among others, and they play an important part in protecting plants against bacterial, viral or fungal infections.

The fungicidal and bactericidal action of many plant essential oils is known, have arrived in some case to be marketed commercially. Among these are jojoba oil (Simmondsia cahfornica), rosemary oil (Rosemarinus officianalis), thyme oil (T. vulgaris), the clarified hydrophobic extract of neem oil (A. indica), cottonseed oil (Gossypium hirsutum) with garlic extract (Dayan, F. E. et al. “Natural products in crop protection”. Bioorg. and Med. Chem. 17 (2009), 4022-4034).

The chemical composition of essential oils differs not only in the quantity but also in the quality and the stereochemical type of the molecules in the extracted substances. The extraction product may vary according to climate, the composition of the soil, the organ of the plant used for extraction, and the age and stage of growth of the plant. It also depends on the extraction process used.

Furthermore, the use of inorganic salts such as the bicarbonates of alkali metals, mainly lithium, sodium or potassium, and ammonium bicarbonate as fungicidal agents is also known from U.S. Pat. No. 5,346,704, the entirety of which is incorporated by reference. The use of these inorganic salts, in particular those containing the bicarbonate anion, does not give rise to any risks to human health or to the environment.

The fungicidal nature of products based on copper or its salts are also known, and these have been extensively used in agriculture. Since then copper-based fungicides have been used in well-known formulae such as Bordeaux mixture (Copper as a Biocidal Tool. Gadi Borkow and Jeffrey Gavia. Current Medicinal Chemistry, volume 12: 2163-2175).

Without being bound to any theory in particular, it is possible that the property of the essential oils obtained from plants in potentiating antifungal activity is due to some of the compounds having known activity present in these essential oils. In embodiments of the present disclosure, the fungicidal composition may comprise a minicell and a bioactive compounds isolated from the essential oils, such as phenolic monoterpenoids such as carvacrol and thymol, allylbenzenes such as eugenol, monosubstituted phenols such as trans-cinamaldehyde, cyclic monoterpenes such as limonene, bicyclic monoterpenes such as camphene and linear terpenes such as nerol, any of their families and mixtures thereof. In embodiments, the bioactive agent has an antifungal, fungistatic, or fungicidal activity.

The mechanism of action of the essential oils is a multiple one due to the complex mixture of different active ingredients which they contain. However the nature of the action of the major components in some of these oils has been described. The best described in the literature is the nature of the action of carvacrol on the growth of bacterial and yeast cells (The phenolic hydroxyl group of carvacrol is essential for action against the food-borne pathogen Bacillus cereus. A. Ultee et al., Applied and Environmental Microbiology, April 2002, 1561-1568). According to these studies carvacrol is capable of crossing the cell membrane when it is protonated (in acid medium) and on reaching the cytoplasm releases a proton, resulting in acidification of the cell. This manner of action does not rule out other possible modes of action such as increase in the permeability of the membrane or specific inhibiting effects on catalytic processes.

Essential oils such as peppermint oil (PO), thyme oil (TO), clove oil (CO), and cinnamon oil (CnO) have been used for their antibacterial, antiviral, anti-inflammatory, antifungal, and antioxidant properties. Terpenoids such as menthol and thymol and phenylpropenes such as eugenol and cinnamaldehyde are components of EOs that mainly influence antibacterial activities. For example, thymol is able to disturb micromembranes by integration of its polar head-groups in lipid bilayers and increase of the intracellular ATP concentration. Eugenol was also found to affect the transport of ions through cellular membranes. Cinnamaldehyde inhibits enzymes associated in cytokine interactions and acts as an ATPase inhibitor.

In some embodiments, terpenes are chemical compounds that are widespread in nature, mainly in plants as constituents of essential oils (EOs). Their building block is the hydrocarbon isoprene (C₅H₈)n.

In some embodiments, examples of terpenes include, but are not limited to citral, pinene, nerol, b-ionone, geraniol, carvacrol, eugenol, carvone, terpeniol, anethole, camphor, menthol, limonene, nerolidol, framesol, phytol, carotene (vitamin A1), squalene, thymol, tocotrienol, perillyl alcohol, borneol, myrcene, simene, carene, terpenene, and linalool.

There are, however, a number of drawbacks to the use of terpenes as EOs, such as (i) terpenes are liquids which can make them difficult to handle and unsuitable for certain purposes; (ii) terpenes are not very miscible with water, and it generally requires the use of detergents, surfactants or other emulsifiers to prepare aqueous emulsions, and (iii) terpenes are prone to oxidation in aqueous emulsion systems, which make long term storage a problem.

That is, the main limitations of EOs comprising terpenes and/or terpenoids are their inherent volatility and propensity to oxidize. These drawbacks limit the long-term fungicidal efficacy of EOs.

The present disclosure teaches novel delivery technologies, such as encapsulation using minicells, to protect the volatile compounds and bioactivity of EOs from (1) degradation and oxidation process occurring during feed processing and storage; (2) different conditions in the field and enable the controlled release; and (3) mixing with other crop inputs.

The present disclosure teaches that bioactive agents with fungicidal activity includes, but are not limited to, sesame oil, pyrethrum (extract), glycerol-derived lipids or glycerol fatty acid derivatives, cinnamon oil, cedar oil, clove oil, geranium oil, lemongrass oil, angelica oil, mint oil, turmeric oil, wintergreen oil, rosemary oil, anise oil, cardamom oil, caraway oil, chamomile oil, coriander oil, guaiacwood oil, cumin oil, dill oil, mint oil, parsley oil, basil oil, camphor oil, cananga oil, citronella oil, eucalyptus oil, fennel oil, ginger oil, copaiba balsam oil, perilla oil, cedarwood oil, jasmine oil, palmarosa sofia oil, western mint oil, star anis oil, tuberose oil, neroli oil, tolu balsam oil, patchouli oil, palmarosa oil, Chamaecyparis obtusa oil, Hiba oil, sandalwood oil, petitgrain oil, bay oil, vetivert oil, bergamot oil, Peru balsam oil, bois de rose oil, grapefruit oil, lemon oil, mandarin oil, orange oil, oregano oil, lavender oil, Lindera oil, pine needle oil, pepper oil, rose oil, iris oil, sweet orange oil, tangerine oil, tea tree oil, tea seed oil, thyme oil, thymol oil, garlic oil, peppermint oil, onion oil, linaloe oil, Japanese mint oil, spearmint oil, ajowan oil, and giant knotweed extract.

In some embodiments, the present disclose teaches a composition comprising: a minicell and a bioactive agent. The bioactive agent is encapsulated by the minicell. The bioactive agent is a biologically active agent. In some embodiments, the biologically active agent is an essential oil.

In some embodiments, the fungicidal compounds or the bioactive agent with fungicidal activity of the present disclosure comprise the essential oil. In some embodiments, the essential oil comprise terpenes (e.g., p-Cymene, limonene, sabinene, a-pinene, y-terpinene, b-caryophyllene), terpenoids (e.g., geraniol, citronellal, thymol, carvacrol, carvone, borneol) and phenylpropanoids (e.g., cinnamaldehyde, eugenol, vanillin, safrole). In further embodiments, the essential oil comprises eugenol, geraniol, or thymol. In embodiments, the essential oil comprises eugenol. In embodiments, the essential oil comprises geraniol. In embodiments, the essential oil comprises thymol.

Essential oils as provided herein also contain essential oils derived from plants (i.e., “natural” essential oils) and additionally or alternatively their synthetic analogues. Some embodiments comprise a combination of essential oils. Other embodiments comprise a combination of natural and synthetic essential oils. In some embodiments, synthetic essential oils can be a synthetic blend, which generally mimics an essential oil assay of a natural essential oil by including at least 5, at least 10, at least 15, or at least 20 of the most critical essential oils within a natural essential oil.

In embodiments, the essential oil itself has fungicidal activity. Exemplary essential oils and extracts, and constituents thereof, useful in the presently disclosed compositions include, but are not limited to: α-pinene, P-pinene, α-campholenic aldehyde, α-citronellol, α-iso-amyl-cinnamic (e.g., amyl cinnamic aldehyde), α-pinene oxide, α-cinnamic terpinene, α-terpineol (e.g., 1-methyl-4-isopropyl-1-cyclohexen-8-ol), λ-terpinene, achillea, aldehyde C16, α-phellandrene, amyl cinnamic aldehyde, allspice oil (pimento berry oil), amyl salicylate, anethole, anise oil, anisic aldehyde, basil oil, bay oil, benzyl acetate, benzyl alcohol, bergamot oil (extracted from plant species, such as, Monardia fistulosa, Monarda didyma, Citrus bergamia, Monarda punctata), bitter orange peel oil, black pepper oil, borneol, calamus oil, camphor oil, cananga oil, cardamom oil, carnation oil (e.g., Dianthus caryophyllus), carvacrol, carveol, cassia oil, castor oil, cedar oil (e.g., hinoki oil), cedar leaf oil, chamomile oil, cineole, cinnamaldehyde, cinnamic alcohol, cinnamon, cis-pinane, citral (e.g., 3,7-dimethyl-2,6-octadienal), citronella oil, citronellal, citronellol dextro (e.g., 3-7-dimethyl-6-octen-1-ol), citronellol, citronellyl acetate, citronellyl nitrile, citrus unshiu peel extract, clary sage oil, clove and clove bud oil (extracted from plant species, such as, Eugenia caryophyllus and Syzgium aromaticum), coriander oil, corn oil, cotton seed oil, d-dihydrocarvone, decyl aldehyde, diethyl phthalate, dihydroanethole, dihydrocarveol, dihydrolinalool, dihydromyrcene, dihydromyrcenol, dihydromyrcenyl acetate, dihydroterpineol, dimethyl salicylate, dimethyloctanal, dimethyloctanol, dimethyloctanyl acetate, diphenyl oxide, dipropylene glycol, d-limonene, d-pulegone, estragole, ethyl vanillin (e.g., 3-ethoxy-4-hydrobenzaldehyde), eucalyptol (e.g., cineole), eucalyptus oil (such as, eucalyptus citriodora, eucalyptus globulus), eugenol (e.g., 2-methoxy-4-allyl phenol), evening primrose oil, fenchol, fennel oil, fish oil, florazon (e.g., 4-ethyl α-α-dimethyl-benzenepropanal), galaxolide, geraniol (e.g., 2-trans-3,7-dimethyl-2,6-octadien-8-ol), geraniol, geranium oil, geranyl acetate, geranyl nitrile, ginger oil, grapefruit oil (derived from the peel pink and white varieties of Citrus paradise) guaiacol, guaiacwood oil, gurjun balsam oil, heliotropin, herbanate (e.g., 3-(1-methyl-ethyl)bicyclo(2,2,1)hept-5-ene-2-carboxylic acid ethyl ester), hib a oil, hydroxycitronellal, 1-carvone, 1-methyl acetate, ionone, isobutyl quinoleine (e.g., 6-secondary butyl quinoline), isobornyl acetate, isobornyl methylether, isoeugenol, isolongifolene, jasmine oil, jojoba oil, juniper berry oil, lavender oil, lavandin oil, lemon grass oil, lemon oil, lime oil, limonene, linallol oxide, linallol, linalool, linalyl acetate, linseed oil, litsea cubeba oil, 1-methyl acetate, longifolene, mandarin oil, menthol crystals, menthol laevo (e.g., 5-methyl-2-isopropyl cyclohexanol), menthol, menthone laevo (e.g., 4-isopropyl-1-methyl cyclohexan-3-one), methyl anthranilate, methyl cedryl ketone, methyl chavicol, methyl hexyl ether, methyl ionone, mineral oil, mint oil, musk oil (such as, musk ambrette, musk ketone, musk xylol), mustard (also known as allylisothio-cyanate), myrcene, nerol, neryl acetate, nonyl aldehyde, nutmeg oil (extracted from the seed of the tree species Myristica fragrans), orange oil extract (extracted from fruit such as, Citrus aurantium dulcis and Citrus sinensis), orris oil (derived from Iris florentina) para-cymene, para-hydroxy phenyl butanone crystals (e.g., 4-(4-hydroxyphenyl)-2-butanone), palmarosa oil (derived from Cymbopogon martini), patchouli oil (derived from Pogostemon cablin), p-cymene, pennyroyal oil, pepper oil, peppermint oil (derived from Mentha piperita), perillaldehyde, petitgrain oil (extracted from the leaves and green twigs of Citrus aurantium amara), phenyl ethyl alcohol, phenyl ethyl propionate, phenyl ethyl-2-methylbutyrate, pinane hydroperoxide, pinanol, pine ester, pine oil, pinene, piperonal, piperonyl acetate, piperonyl alcohol, plinol, plinyl acetate, pseudo ionone, rhodinol, rhodinyl acetate, rose oil, rosemary oil (derived from Rosmarinus officinalis) sage oil (derived from Salvia officinalis), sandalwood oil (derived from Santalum album), sandenol, sassafras oil, sesame oil, soybean oil, spearmint oil, spice oils (such as, but not limited to, caraway seed oil, celery oil, dill seed oil, marjoram oil), spike lavender oil (derived from Lavandula latifolia), spirantol, starflower oil (also known as, borage oil), tangerine oil (derived from Citrus reticulata), tea seed oil, tea tree oil, terpenoid, terpineol, terpinolene, terpinyl acetate, tert-butylcyclohexyl acetate, tetrahydrolinalool, tetrahydrolinalyl acetate, tetrahydromyrcenol, thulasi oil, thyme oil, thymol, trans-2-hexenol, trans-anethole and metabolites thereof, turmeric oil, turpentine, vanillin (e.g., 4-hydroxy-3-methoxy benzaldehyde), vetiver oil, white cedar oil (derived from Thuja occidentalis), wintergreen oil (methyl salicylate) and the like.

In some embodiments, the composition comprises thyme oil, and the thyme oil comprises a major constituent selected from the group consisting of thymol, camphor, ρ-cymene, γ-terpinene and caravacrol. In some other embodiments, the thyme oil comprises one or more minor constituent selected from the group consisting of myrcene, α-pinene, camphene, borneol, β-caryophyllene, 1,3 -octadiene, 1,7-acadiene, 2,4-dymethyl-2,4-heptadiene, sabinene, para-menthene-1, para-menthene-3, α-phellandrene, α-terpinene, limonene, (Z)-b-ocimene, (E)-b-ocimene, α-terpinolene, metha-3,8-diene, p-cimenen, trans-dihydrocarvone, thymol methyl ether, carvacrol acetate, β-caryophyllene, calamenene, gamma-cadinene, β-pinene and linalool.

In still other embodiments of any of the disclosed compositions, the essential oil comprises a constituent selected from α-pinene, β-pinene, pulegone, anisole, eucalyptol, eugenol, geraniol, geranyl acetate, linalyl acetate, methyl anthranilate, myrcene, thymol and cymene. In further embodiments of any of the disclosed compositions, the essential oil comprises an eugenol, a geraniol, or a thymol.

In some embodiments, the essential oils can include oils from the classes of terpenes, terpenoids, phenylpropenes and combinations thereof.

The present disclosure provide exemplary botanical fungicides (i.e. biofungicides), which are essential oils obtained from Calocedrus macrolepis var. formosana, O. acutidens, cymbopogan (Cymbopogon citrates), Ocimum gratissimum, Thymus vulgaris, Bergamot (Citrus hystrix), tea tree (Melaleuca alternifolia) and Asarum heterotropoides var. mandshuricum. These biofungicides show antifungal activity against Amaranthus retroflexus, Chenopodium album, and Rumex crispus, S. sclerotiorum, Rhizoctonia solani, Rhizopus stolonifer, Mucor spp, A. brassicicola, A. flavus, Bipolaris oryzae, F. moniliforme, F. oxysporum, F. proliferatum, M oryzae, A. humicola, Colletotrichum. gloeosporioides, and Phytophthora cactorum.

### Target and Locus of Fungicidal Compositions

The present disclosure relates to the control of one or more fungi and their spores with a composition or formulation comprising a minicell and one or more bioactive agents with fungicidal activity.

The term “locus” as used herein refers to a place to which a composition according to the disclosure is applied. It includes application to an individual plant, a group of plants such as a plant and/or its surrounds or in a group and the region in which plants may be planted, as well application directly to fungi or their spores and/or the vicinity in which they are located. In some embodiments, the term “locus” means fields in or on which plants are growing, or where seeds of cultivated plants are sown, or where seed will be placed into the soil. It includes soil, seeds, and seedlings, as well as established vegetation. In further embodiments, “locus”, “subject”, or “target” can be interchangeably used in this disclosure.

In one embodiment, the fungi pest is a plant pest and the method comprises applying the composition or formulation of the present disclosure to the plant or its surroundings.

Embodiments of the disclosure can be used to treat crops in order to limit or prevent fungal infection or fungal diseases. The present disclosure is especially suitable for agronomically important plants, which refers to a plant that is harvested or cultivated on a commercial scale.

Examples of crops of useful plants in which the composition of the disclosure can be used include perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, okra, onion, pepper, potato, sweet potato, pumpkin, rhubarb, spinach and tomato; and vines for example grapes.

Crops are to be understood as being those which are naturally occurring, obtained by conventional methods of breeding, or obtained by genetic engineering. They include crops which contain so-called output traits such as improved storage stability, higher nutritional value and improved flavour.

In an embodiment plants include fibre plants, grain crops, legume crops, pulse crops, vegetables and fruit, more particularly, cotton, maize, sorghum, sunflower, lucerne, various legumes especially soybean, pigeon pea, mung bean and chickpea, tomatoes, okra and like plants.

In an embodiment plants include ornamental plants. By way of example these ornamental plants may be orchids, roses, tulips, trees, shrubs, herbs, lawns and grasses, bulbs, vines, perennials, succulents, house plants.

Those skilled in the art will recognize that not all compounds are equally effective against all fungi and plant pathogens. In embodiments the compositions display antifungal, fungistatic, or fungicidal activity against fungi or fungal-like microorganisms, which may include economically important agronomic, forest, greenhouse, nursery, ornamentals, food and fiber, public and animal health, domestic and commercial structure, household, and stored product pests.

The compositions and methods of the present disclosure is effective against harmful microorganisms, such as microorganisms, that cause phytopathogenic diseases, in particular against phytopathogenic fungi, fungal-like microorganisms, or bacteria.

The composition of the invention may be used to control plant diseases caused by a broad spectrum of fungal plant pathogens in the Basidiomycete, Ascomycete, Oomycete, Deuteromycete, Blasocladiomycete, Chrytidiomycete, Glomeromycete and/or Mucoromycete classes.

The composition is effective in controlling a broad spectrum of plant diseases, such as foliar pathogens of ornamental, turf, vegetable, field, cereal, and fruit crops.

The fungicidal compositions and methods of the present invention are suitable for the use in the treatment of plants against diseases and pathogenic fungi selected from the group consisting of:

Powdery Mildew Diseases such as Blumeria diseases caused for example by Blumeria graminis; Podosphaera diseases caused for example by Podosphaera leucotricha; Sphaerotheca diseases caused for example by Sphaerotheca fuliginea; Uncinula diseases caused for example by Uncinula necator;

Rust Diseases such as Gymnosporangium diseases caused for example by Gymnosporangium sabinae; Hemileia diseases caused for example by Hemileia vastatrix; Phakopsora diseases caused for example by Phakopsora pachyrhizi and Phakopsora meibomiae; Puccinia diseases caused for example by Puccinia recondita, Puccinia graminis or Puccinia striiformis; Uromyces diseases caused for example by Uromyces appendiculatus;

Oomycete Diseases such as Albugo diseases caused for example by Albugo candida; Bremia diseases caused for example by Bremia lactucae; Peronospora diseases caused for example by Peronospora pisi and Peronospora brassicae; Phytophthora diseases caused for example by Phytophthora infestans;

Plasmopara diseases caused for example by Plasmopara viticola; Pseudoperonospora diseases caused for example by Pseudoperonospora humuli and Pseudoperonospora cubensis; Pythium diseases caused for example by Pythium ultimum;

Leaf spot, Leaf blotch and Leaf Blight Diseases such as Alternaria diseases caused for example by Alternaria solani; Cercospora diseases caused for example by Cercospora beticola; Cladiosporium diseases caused for example by Cladiosporium cucumerinum; Cochliobolus diseases caused for example by Cochliobolus sativus (Conidiaform: Drechslera, Syn: Helminthosporium) or Cochliobolus miyabeanus; Colletotrichum diseases caused for example by Colletotrichum lindemuthianum; Cycloconium diseases caused for example by Cycloconium oleaginum; Diaporthe diseases caused for example by Diaporthe citri; Elsinoe diseases caused for example by Elsinoe fawcettii; Gloeosporium diseases caused for example by Gloeosporium laeticolour; Glomerella diseases caused for example by Glomerella cingulata; Guignardia diseases caused for example by Guignardia bidwellii; Leptosphaeria diseases caused for example by Leptosphaeria macularis and Leptosphaeria nodorum; Magnaporthe diseases caused for example by Magnaporthe grisea; Mycosphaerella diseases caused for example by Mycosphaerella graminicola, Mycosphaerella arachidicola and Mycosphaerella fijiensis; Phaeosphaeria diseases caused for example by Phaeosphaeria nodorum; Pyrenophora diseases caused for example by Pyrenophora teres or Pyrenophora tritici repentis; Ramularia-diseases caused for example by Ramularia collo-cygni or Ramularia areola; Rhynchosporium diseases caused for example by Rhynchosporium secalis; Septoria diseases caused for example by Septoria apii and Septoria lycopersici; Typhula diseases caused for example by Thyphula incarnata; Venturia diseases caused for example by Venturia inaequalis;

Root-, Sheath and Stem Diseases such as Corticium diseases caused for example by Corticium graminearum; Fusarium diseases caused for example by Fusarium oxysporum; Gaeumannomyces diseases caused for example by Gaeumannomyces graminis; Rhizoctonia diseases caused for example by Rhizoctonia solani; Sarocladium diseases caused for example by Sarocladium oryzae; Sclerotium diseases caused for example by Sclerotium oryzae; Tapesia diseases caused for example by Tapesia acuformis; Thielaviopsis diseases caused for example by Thielaviopsis basicola;

Ear and Panicle Diseases including Maize cob such as Alternaria diseases caused for example by Alternaria spp.; Aspergillus diseases caused for example by Aspergillus flavus; Cladosporium diseases caused for example by Cladiosporium cladosporioides; Claviceps diseases caused for example by Claviceps purpurea; Fusarium diseases caused for example by Fusarium culmorum; Gibberella diseases caused for example by Gibberella zeae; Monographella diseases caused for example by Monographella nivalis;

Smut- and Bunt Diseases such as Sphacelotheca diseases caused for example by Sphacelotheca reiliana; Tilletia diseases caused for example by Tilletia caries; Urocystis diseases caused for example by Urocystis occulta; Ustilago diseases caused for example by Ustilago nudes;

Fruit Rot and Mould Diseases such as Aspergillus diseases caused for example by Aspergillus flavus; Botrytis diseases caused for example by Botrytis cinerea; Penicillium diseases caused for example by Penicillium expansum and Penicillium purpurogenum; Rhizopus diseases caused by example by Rhizopus stolonifer. Sclerotinia diseases caused for example by Sclerotinia sclerotiorum; Verticillium diseases caused for example by Verticillium alboatrum; Seed- and Soilborne Decay, Mould, Wilt, Rot and Damping-off diseases such as Alternaria diseases caused for example by Alternaria brassicicola; Aphanomyces diseases caused for example by Aphanomyces euteiches; Ascochyta diseases caused for example by Ascochyta lentis; Aspergillus diseases caused for example by Aspergillus flavus; Cladosporium diseases caused for example by Cladosporium herbarum; Cochliobolus diseases caused for example by Cochliobolus sativus; (Conidiaform: Drechslera, Bipolaris Syn: Helminthosporium); Colletotrichum diseases caused for example by Colletotrichum coccodes; Fusarium diseases caused for example by Fusarium culmorum; Gibberella diseases caused for example by Gibberella zeae; Macrophomina diseases caused for example by Macrophomina phaseolina; Microdochium diseases caused for example by Microdochium nivale; Monographella diseases caused for example by Monographella nivalis; Penicillium diseases caused for example by Penicillium expansum; Phoma diseases caused for example by Phoma lingam; Phomopsis diseases caused for example by Phomopsis sojae; Phytophthora diseases caused for example by Phytophthora cactorum; Pyrenophora diseases caused for example by Pyrenophora graminea; Pyricularia diseases caused for example by Pyricularia oryzae; Pythium diseases caused for example by Pythium ultimum; Rhizoctonia diseases caused for example by Rhizoctonia solani; Rhizopus diseases caused for example by Rhizopus oryzae; Sclerotium diseases caused for example by Sclerotium rolfsii; Septoria diseases caused for example by Septoria nodorum; Typhula diseases caused for example by Typhula incarnata; Verticillium diseases caused for example by Verticillium dahliae;

Canker, Broom and Dieback Diseases such as Nectria diseases caused for example by Nectria galligena;

Blight Diseases such as Monilinia diseases caused for example by Monilinia taxa;

Leaf Blister or Leaf Curl Diseases including deformation of blooms and fruits such as Exobasidium diseases caused for example by Exobasidium vexans;

Taphrina diseases caused for example by Taphrina deformans;

Decline Diseases of Wooden Plants such as Esca disease caused for example by Phaeomoniella clamydospora, Phaeoacremonium aleophilum and Fomitiporia mediterranea; Ganoderma diseases caused for example by Ganoderma boninense; Rigidoporus diseases caused for example by Rigidoporus lignosus;

Diseases of Flowers and Seeds such as Botrytis diseases caused for example by Botrytis cinerea;

Diseases of Tubers such as Rhizoctonia diseases caused for example by Rhizoctonia solani; Helminthosporium diseases caused for example by Helminthosporium solani;

Club root diseases such as Plasmodiophora diseases, cause for example by Plamodiophora brassicae.

Diseases caused by Bacterial Organisms such as Xanthomonas species for example Xanthomonas campestris pv. oryzae; Pseudomonas species for example Pseudomonas syringae pv. lachrymans; Erwinia species for example Er winia amylovora.

Preferably the active compound combinations and the fungicidal compositions of the present invention are used for controlling pathogenic fungi, selected from the group consisting of Pyrenophora/Drechslera (including Pyrenophora/Drechslera tritici-repentis and Pyrenophora/Drechslera teres), Septoria (including Septoria nodorum, Septoria tritici), Puccinia, Erysiphe (synonym: Blumeria), Leptosphaeria (including Leptosphaeria nodorum) and Pseudocercosporella (synonym: Tapesia/Oculimacula). Most preferred is the treatment of Septoria, Pyrenophora and Leptosphaeria, especially Pyrenophora tritici-repentis, Septoria nodorum, Septoria tritici and Leptosphaeria nodorum. According to an also preferred embodiment of the present invention, the active compound combinations and the fungicidal compositions of the present invention are used for controlling pathogenic fungi, selected from the group consisting of Tapesia/Oculimacula/Pseudocercosporella species, Septoria tritici, Leptosphaeria nodorum, Puccinia triticiana, Puccinia striifomis, Pyrenophora/Drechslera tritici-repentis, Blumeria graminis/Erysiphe graminis, Fusarium spp., Rhynchosporium secalis, Pyrenophora/Drechslera teres, Puccinia hordei, and Ramularia collo-cygni.

In further embodiments, the composition of the present disclosure is effective against phytopathogenic fungi belonging to the following classes: Ascomycetes (e.g. Venturia, Podosphaera, Erysiphe, Monilinia, Mycosphaerella, Uncinula); Basidiomycetes (e.g. the genus Hemileia, Rhizoctonia, Phakopsora, Puccinia, Ustilago, Tilletia); fungi imperfecti (also known as Deuteromycetes; e.g. Botrytis, Helminthosporium, Rhynchosporium, Fusarium, Septoria, Cercospora, Alternaria, Pyricularia and Pseudocercosporella); Oomycetes (e.g. Phytophthora, Peronospora, Pseudoperonospora, Albugo, Bremia, Pythium, Pseudosclerospora, Plasmopara).

The compositions of the present disclosure are effective to knockdown and/or kill a wide range of pathogenic fungi and fungal-like microorganisms.

The present disclosure teaches application of the fungicidal composition of the present disclosure improves growth in one or more crops. In some embodiments, said improved growth is selected from the group consisting of preventively and/or curatively controlling pathogenic fungi and/or nematodes, resistance management, and improved plant physiology effects selected from enhanced root growth, improved greening, improved water use efficiency, improved nitrogen-use efficiency, delayed senescence and enhanced yield.

In some embodiments, the bioactive agent in the presence of the minicell has at least 1%, at least 2%, at least 3%, at least 4%, at least 5%, at least 6%, at least 7%, at least 8%, at least 9%, at least 10%, at least 15%, at least 20%, at least 30%, at least 40%, at least 50%, at least 60%, at least 70%, at least 80%, at least 90% higher fungicidal activity than the bioactive agent alone at least 1 hour, at least 2 hours, at least 6 hours, at least 12 hours, or at least 24 hours after treatment of said composition.

In some embodiments, the fungicidal effect is an effect wherein treatment with a composition causes at least about 1%, at least about 2%, at least about 3%, at least about 4%, at least about 5%, at least about 6%, at least about 7%, at least about 8%, at least about 9%, at least about 10%, at least about 15%, at least about 20% of the exposed fungi to be killed. In some embodiments, the fungicidal effect is an effect wherein treatment with a composition causes at least about 25% of the exposed fungi to die. In some embodiments the fungicidal effect is an effect wherein treatment with a composition causes at least about 50% of the exposed fungi to be killed. In some embodiments the fungicidal effect is an effect wherein treatment with a composition causes at least about 75% of the exposed fungi to be killed. In some embodiments the fungicidal effect is an effect wherein treatment with a composition causes at least about 90% of the exposed fungi to be killed.

### Fungicidal Compositions

The present disclosure teaches a composition or formulation comprising a minicell and at least one fungicidal ingredient (i.e. a bioactive agent with fungicidal activity or a component of the bioactive agent). In some embodiments, the fungicidal ingredients can be applied in the form of compositions and can be applied to the crop area or plant to be treated, simultaneously or in succession, with other compounds. The other compounds can be fertilizers, weed killers, Cryoprotectants, surfactants, detergents, pesticidal soaps, dormant oils, polymers, and/or time-release or biodegradable carrier formulations that permit long-term dosing of a target area following a single application of the formulation. They can also be chemical insecticides, herbicides, virucides, microbicides, amoebicides, pesticides, fungicides, bacteriocides, nematocides, molluscicides or mixtures of several of these preparations, if desired, together with further agriculturally acceptable carriers, surfactants or application-promoting adjuvants customarily employed in the art of formulation. Suitable carriers and adjuvants can be solid or liquid and correspond to the substances ordinarily employed in formulation technology, e.g. natural or regenerated mineral substances, solvents, dispersants, wetting agents, tackifiers, binders or fertilizers.

The compositions of the present disclosure can be formulated or mixed with, if desired, conventional inert fungicide diluents or extenders of the type usable in conventional pest control agents, e.g., conventional dispersible carrier vehicles in the form of solutions, emulsions, suspensions, emulsifiable concentrates, spray powders, pastes, soluble powders, dusting agents, granules or foams.

As used herein, the term “emulsion” refers to a fine dispersion of droplets of one liquid in which the liquid is not substantially soluble or miscible. An essential oil may be emulsified or substantially emulsified within an aqueous carrier.

As used herein, the term “emulsifier” refers to a substance that stabilizes an emulsion. The emulsifier can utilize physical properties, chemical properties, or utilize both physical and chemical properties to interact with one or more substances of an emulsion.

Typical emulsifiers that may be suitable for use in the compositions of the disclosure, include, but are not limited to, light molecular weight oils without fungicidal activity (e.g., canola, cottonseed, groundnut, corn, germ, olive, castor and sesame oils), and non-ionic, anionic and cationic surfactants. Blends of any of the above emulsifiers may also be used in the compositions of the present disclosure.

Typical non-ionic surfactants include ethoxylated alkanols, in particular ethoxylated fatty alcohols and ethoxylated oxoalcohols, such as ethoxylated lauryl alcohol, ethoxylated isotridecanol, ethoxylated cetyl alcohol, ethoxylated stearyl alcohol, and esters thereof, such as acetates; ethoxylated alkylphenols, such as ethoxylated nonylphenyl, ethoxylated dodecylphenyl, ethoxylated isotridecylphenol and the esters thereof, e.g. the acetates alkylglucosides and alkyl polyglucosides, ethoxylated alkylglucosides; ethoxylated fatty amines, ethoxylated fatty acids, partial esters, such as mono-, di- and triesters of fatty acids with glycerine or sorbitan, such as glycerine monostearate, glycerine monooleate, sorbitanmonolaurate, sorbitanmonopalmitate, sorbitanmonostearate, sorbitan monooleate, sorbitantristearate, sorbitan trioleate; ethoxylated esters of fatty acids with glycerine or sorbitan, such as polyoxyethylene glycerine monostearate, polyoxyethylene sorbitanmonolaurate, sorbitanmonopalmitate, polyoxyethylene sorbitanmonostearate, polyoxyethylene sorbitan monooleate, polyoxyethylene sorbitantristearate, polyoxyethylene sorbitan trioleate; ethoxylates of vegetable oils or animal fats, such as corn oil ethoxylate, castor oil ethoxylate, tallow oil ethoxylate; ethoxylates of fatty amines, fatty amides or of fatty acid diethanolamides.

Typical anionic surfactants include salts, in particular, sodium, potassium calcium or ammonium salts of alkylsulfonates, such as lauryl sulfonate, isotridecylsulfonate, alkylsulfates, in particular fatty alcohol sulfates, such as lauryl sulfate, isotridecylsulfate, cetylsulfate, stearyl sulfate-aryl- and alkyl aryl sulfonates, such as napthyl sulfonate, dibutylnaphtylsulfonate, alkyldiphenylether sulfonates such as dodecyldiphenylether sulfonate, alkylbenzene sulfonates such as cumylsulfonate, nonylbenzenesulfonate and dodecylbenzene sulfonate; sulfonates of fatty acids and fatty acid esters; —sulfates of fatty acids and fatty acid esters; sulfates of ethoxylated alkanols, such as sulfates of ethoxylated lauryl alcohol; sulfates of alkoxylated alkylphenols; alkylphosphates and dialkylphosphates; dialkylesters of sulfosuccinic acid, such as dioctylsulfosuccinate, acylsarcosinates, fatty acids, such as stearates, acylglutamates, ligninsulfonates, low molecular weight condensates of naphthalinesulfonic acid or phenolsulfonic acid with formaldehyde and optionally urea.

Typical cationic surfactants include quaternary ammonium compounds, in particular alkyltrimethylammonium salts and dialkyldimethylammonium salts, e.g. the halides, sulfates and alkylsulfates.

In some embodiments, the biofungicidal compositions can be combined with one or more synthetic fungicides or pesticides. In one embodiment, the fungicide or pesticide is selected from one or more of A) azoles, selected from the group consisting of azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, 1-(4-chloro-phenyl)-2-([1,2,4]triazol-1-y1)-cycloheptanol, cyazofamid, imazalil, pefurazoate, prochloraz, triflumizol, benomyl, carbendazim, fuberidazole, thiabendazole, ethaboxam, etridiazole, and 2-(4-chloro-phenyl)-N-[4-(3,4-dimethoxy-phenyl)-isoxazol-5-yl]-2-prop-2-ynyloxy-acetamide; B) strobilurins, selected from the group consisting of azoxystrobin, dimoxystrobin, enestroburin, fluoxastrobin, kresoxim-methyl, metominostrobin, orysastrobin, picoxystrobin, pyracl ostrob in, pyribencarb, trifloxystrobin, 2-(2-(6-(3-chloro-2-methyl-phenoxy)-5-fluoro-pyrimidin-4-loxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)-carbamate, and 2-(2-(3-(2,6-dichlorophenyl)-1-methyl-allylideneaminooxy-methyl)-phenyl)-2-methoxyimino-N-methyl-acetamide; C) carboxamides, selected from the group consisting of benalaxyl, benalaxyl-M, benodanil, bixafen, boscalid, carboxin, fenfuram, fen-hexamid, flutolanil, furametpyr, isopyrazam, isotianil, kiralaxyl, mepronil, metalaxyl, metalaxyl-M (mefenoxam), ofurace, oxadixyl, oxycarboxin, penthiopyrad, sedaxane, tecloftalam, thifluzamide, tiadinil, 2-amino-4-methyl-hiazole-5-carboxanilide, 2-chloro-N-(1,1,3-trimethyl-indan-4-yl)-nicotinamide, N-(3′, 4′,5′-trifluorobiphenyl-2-yl)-3-difluoromethyl-1-methyl-1H-pyrazole-4-carboxamide, N-(4′-trifluoromethylthi obiphenyl-2-yl)-3-difluoromethyl- 1 -methyl-1H-pyrazole-4-carboxamide, -(2-(1,3-dimethyl-butyl)-phenyl)-1,3-dimethyl-5-fluoro-1H-pyrazole-4-carboxamide and N-(2-(1,3,3-trimethyl-butyl)-phenyl)-1,3-dimethyl-5-fluoro-1H-pyrazole-4-carboxamide, dimethomorph, flumorph, pyrimorph, flumetover, fluopicolide, fluopyram, zoxamide, N-(3-Ethyl-3,5,5 -tri ethyl-cyclohexyl)-3-formyl amino-2-hydroxy-benzamide, carpropamid, dicyclomet, mandiproamid, oxytetracyclin, silthiofarm, and N-(6-methoxy-pyridin-3-yl)cyclopropanecarboxylic acid amide; D) heterocyclic compounds, selected from the group consisting of fluazinam, pyrifenox, 3[5-(4-chloro-phenyl)-2,3-dimethyl-isoxazolidin-3-yl]-pyridine, 3[5-(4-methyl-phenyl)-2,3-dimethyl- isoxazolidin-3-yl]-pyridine, 2,3,5,6-tetra-chloro-4-methanesulfonyl-pyridine, 3,4,5-trichloropyridine-2,6-di-carbonitrile, N-(1-(5-bromo-3-chloro-pyridin-2-yl)-ethyl)-2,4-dichloro-nicotinamide, N-[(5-bromo-3-chloro-pyridin-2-yl)-methyl]-2,4-dichloro-nicotinamide, bupirimate, cyprodinil, diflumetorim, fenarimol, ferimzone, mepanipyrim, nitrapyrin, nuarimol, pyrimethanil, triforine, fenpiclonil, fludioxonil, aldimorph, dodemorph, dodemorph-acetate, fenpropimorph, tridemorph, fenpropidin, fluoroimid, iprodione, procymidone, vinclozolin, famoxadone, fenamidone, flutianil, octhilinone, probenazole, 5-amino-2-iso-propyl-3-oxo-4-ortho-tolyl-2,3-dihydro-pyrazole-1 -carbothioic acid S-ally ester, acibenzolar-5-methyl, amisulbrom, anilazin, blasticidin-S, captafol, captan, chinomethionat, dazomet, debacarb, diclomezine, difenzoquat, difenzoquat-methyl sulfate, fenoxanil, Folpet, oxolinic acid, piperalin, proquinazid, pyroquilon, quinoxyfen, triazoxide, tricyclazole, 2-butoxy-6-iodo-3-propylchromen-4-one, 5-chloro-1 -(4,6-dimethoxy-pyrimidin-2-yl)-2-methyl-1H-benzoimidazole, 5-chloro-7-(4-methylpiperi din-1 -yl)-6-(2,4,6-trifluorophenyl)-[1,2,4]triazolo[ 1,5-a]pyrimi dine, and 5-ethyl-6-octyl[1,2,4]triazol o[1,5-a]pyri-midine-7-ylamine; E) carbamates, selected from the group consisting of ferbam, mancozeb, maneb, metam, methasulphocarb, metiram, propineb, thiram, zineb, ziram, benthiavalicarb, diethofencarb, iprovalicarb, propamocarb, propamocarb hydrochlorid, valiphenal, and N-(1-(1-(4-cyano-phenyl)-ethanesulfonyl)-but-2-yl) carbamic acid-(4-fluorophenyl)ester; and F) other active compounds, selected from the group consisting of guanidines: guanidine, dodine, dodine free base, guazatine, guazatine-acetate, iminoctadine, iminoctadine-triacetate, iminoctadine-tris(albesilate); nitrophenyl derivates: binapacryl, dinobuton, dinocap, nitrthal-isopropyl, tecnazen; organometal compounds: fentin salts, such as fentin-acetate, fentin chloride or fentin hydroxide; sulfur-containing heterocyclyl compounds: dithianon, isoprothiolane; organophosphorus compounds: edifenphos, fosetyl, fosetyl-aluminum, iprobenfos, phosphorous acid and its salts, pyrazophos, tolclofos-methyl; organochlorine compounds: chlorothalonil, dichlofluanid, dichlorophen, flusulfamide, hexachlorobenzene, pencycuron, pentachlorphenole and its salts, phthalide, quintozene, thiophanate-methyl, tolylfluanid, N-(4-chloro-2-nitro-phenyl)-N-ethyl-4-methyl-benzenesulfonamide; inorganic active substances: Bordeaux mixture, copper acetate, copper hydroxide, copper oxychloride, basic copper sulfate, sulfur; others: biphenyl, bronopol, cyflufenamid, cymoxanil, diphenylamin, metrafenone, mildiomycin, oxin-copper, prohexadione-calcium, spiroxamine, tolylfluanid, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2, 5-dimethyl-phenyl)-N-ethyl-N-methyl formamidine, N′-(4-(4-fluoro-3-trifluoromethyl-phenoxy)-2, 5-dimethyl- phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4 tetrahy dro-naphthalen-1-yl)-amide, 2-{1-[2-(5-methyl-3-trifluoromethyl-pyrazole-1-yl)-acetyl]-piperidin-4-yl}-thiazol e-4-carboxylic acid methyl-(R)-1,2,3,4-tetrahydro-naphthal en-1-yl-amide, acetic acid 6-tert-butyl-8-fluoro-2,3-dimethyl-quinolin-4-yl ester and methoxy-acetic acid 6-tert-butyl-8-fluoro-2,3-dimethyl-quinolin-4-yl ester and mixtures thereof.

The compositions of the present disclosure can be used to control pathogenic fungi or fungal-like microorganisms by either treating a host directly, or treating an area in which the host will be located. For example, the host can be treated directly by using a spray formulation, which can be applied to a plant individually or when grouped, such as an agricultural crop.

The formulation of the present disclosure may further comprise other formulation auxiliaries known in the art of agrochemical formulations in customary amounts. Such auxiliaries include, but are not limited to, antifreeze agents (such as but not limited to glycerine, ethylene glycol, propylene glycol, monopropylene glycol, hexylene glycol, 1-methoxy-2-propanol, cyclohexanol), buffering agents (such as but not limited to sodium hydroxide, phosphoric acid), preserving agents (such as but not limited to derivatives of 1,2-benzisothiazolin-3-one, benzoic acid, sorbic acid, formaldehyde, a combination of methyl parahydroxybenzoate and propyl parahydroxybenzoate), stabilizing agents (such as but not limited to acids, preferably organic acids, such as dodecylbenzene sulfonic acid, acetic acid, propionic acid or butyl hydroxyl toluene, butyl hydroxyl anisole), thickening agents (such as but not limited to heteropolysaccharide and starches), and antifoaming agents (such as but not limited to those based on silicone, particularly polydimethylsiloxane). Such auxiliaries are commercially available and known in the art.

The composition according to this disclosure may be applied in agriculture to protect crops from the stage of germination to harvesting, and during the storage and transport of these crops, seeds, flowers or grains. Likewise another possible application is in the elimination of fungi which attack painted surfaces and to protect carpets and fabrics in the home and in any other application against fungal attack through contact.

### Use of AgriCell Platform for Controlling fungi

As used herein, the term “AgriCell” refers to a “minicell” taught herein, both of which are interchangeably used.

Once the AgriCell is loaded with active ingredients, it serves as a carrier that protects them from environmental stresses until it delivers its high-payload capacity slowly to the plant microenvironment through the natural breakdown of its biodegradable membrane. This bio-encapsulation technology overcomes many of the problems of agrochemical delivery and can serve as the much-needed replacement to traditional techniques using plastic microcapsules. The AgriCell technology can also be engineered in various ways to improve its stability and provide tailored controlled release profiles. The major benefit of this platform is the enhanced efficacy/potency of the active in the field setting.

The present disclosure teaches that the AgriCell platform can be used to effectively deliver one or more fungicidal ingredients (i.e. one or more bioactive agents with fungicidal activity) for controlling fungi. Fungicidal ingredients that cannot be expressed in the host bacterial system can be loaded into “empty” minicells. Once the ingredients or bioactive agents are encapsulated by the minicell, the minicell can be processed to improve the strength of its membrane for enhanced delivery and uptake. Encapsulated biofungicides can be used to show enhanced fungicidal activity, prolonged/extended fungicidal activity, controlled release of biofungicides, efficient controlling or killing of pathogenic fungi, less or non-toxicity to a plant, and environments around the plant.

The present disclosure provides that AgriCell platform can protect the bioactive agent with fungicidal activity, and ensure their delivery to a locus for environment-friendly, sustainable, controllable and scalable control of fungi and fungal-like microorganisms. Without proper protection, unencapsulated fungicidal ingredients of the present disclosure may act quickly, degrade rapidly. Consequently, the use of AgriCell platform provides improved performance of the fungicidal ingredients in terms of stability, storage, and bioavailability through an encapsulation and controlled release mechanism.

The present disclosure teaches that the AgriCell platform can be applied to encapsulation of fungicidal ingredients of interest for controlling or preventing the growth of fungi. The AgriCell platform, showing improved stability and bioavailability, long lasting shelf-life and controlled release properties, can be used for better fungal control than conventional ways of fungal control using fungicides not protected or encapsulated by the AgriCell platform.

### Encapsulation

The present disclosure teaches a composition comprising: a minicell and a bioactive agent with fungicidal activity. In some embodiments, the bioactive agent is encapsulated by the minicell.

In some embodiments, the minicell and the bioactive agent are present in a weight-to-weight ratio of about 5:1 to about 1:5 in the composition. In some embodiments, the minicell and the bioactive agent are present in a weight-to-weight ratio of about 4:1 to about 1:4 in the composition. In some embodiments, the minicell and the bioactive agent are present in a weight-to-weight ratio of about 3:1 to about 1:3 in the composition. In some embodiments, the minicell and the bioactive agent are present in a weight-to-weight ratio of about 2:1 to about 1:2 in the composition. In some embodiments, the minicell and the bioactive agent are present in a weight-to-weight ratio of about 1:1 in the composition.

In some embodiments, at least about 1%, at least about 2%, at least about 3%, at least about 4%, at least about 5%, at least about 6%, at least about 7%, at least about 8%, at least about 9%, at least about 10%, at least about 20%, at least about 30%, at least about 40%, at least about 50%, at least about 60%, at least about 70%, at least about 80%, at least about 90%, of the bioactive agent is encapsulated by the minicell.

In some embodiments, at least about 10% of the bioactive agent is encapsulated by the minicell.

In some embodiments, the minicell stabilizes the bioactive agent in an acidic condition. The acidic condition is less than pH 7, pH 6, pH 5, pH 4, pH 3, or pH 2. In some embodiments, the minicell encapsulating the bioactive agent is preserved from depletion flocculation when a pH is adjusted to an extremely acidic condition. In some embodiments, the acidic condition is as low as pH 1, pH 2, pH 3, pH 4, pH 5, or pH 6.The extremely acidic condition is as low as pH 1.

In other embodiments, the minicell stabilizes the bioactive agent at least 1 day, at least 2 days, at least 3 days, at least 4 days, at least 5 days, at least 6 days, at least 7 days, at least 8 days, at least 9 days, at least 10 days, at least 11 days, at least 12 days, at least 13 days, at least 14 days, at least 15 days, at least 16 days, at least 17 days, at least 18 days, at least 19 days, at least 20, at least 21 days, at least 22 days, at least 23 days, at least 24 days, at least 25 days, at least 26 days, at least 27 days, at least 28 days, at least 29 days, at least 30 days, at least 31 days, at least 32 days, at least 33 days, at least 34 days, at least 35 days, at least 36 days, at least 37 days, at least 38 days, at least 39 days, at least 40 days, at least 45 days, at least 50 days, at least 55 days, or at least 60 days, at room temperature in a neutral pH condition. In other embodiments, the minicell stabilizes the bioactive agent at least 30 days, at room temperature in a neutral pH condition.

In some embodiments, the minicell stabilizes the bioactive agent in a thermal variation. In some embodiments, the bioactive agent encapsulated by the minicell is at least 1.1 fold, at least 1.2 fold, at least 1.3 fold, at least 1.4 fold, at least 1.5 fold, at least 1.6 fold, at least 1.7 fold, at least 1.8 fold, at least 1.9 fold, at least 2 fold, at least 3 fold, at least 4 fold, at least 5 fold more resistant to thermal degradation than a free bioactive agent not encapsulated by the minicell after a heat treatment. In other embodiments, the heat treatment is above room temperature, which is at 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., or higher.

In other embodiments, the bioactive agent encapsulated by the minicell is at least 1.1 fold more resistant to thermal degradation than a free bioactive agent not encapsulated by the minicell after a heat treatment. In further embodiments, the bioactive agent encapsulated by the minicell is at least 1.1 fold more resistant to thermal degradation than a free bioactive agent not encapsulated by the minicell after a heat treatment on day 7 after a heat treatment at 40° C.

In some embodiments, the bioactive agent encapsulated by the minicell has less than about 90%, less than about 85%, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%,or less than about 10% thermal degradation after a heat treatment.

In some embodiments, the bioactive agent encapsulated by the minicell has less than about 60% thermal degradation after a heat treatment. In some embodiments, the bioactive agent encapsulated by the minicell has less than about 60% thermal degradation on day 7 after a heat treatment at 40° C.

In some embodiments, the minicell protects the bioactive agent from oxidative degradation by ultraviolet (UV) or visible light. In some embodiments, the bioactive agent encapsulated by the minicell is at least 1.1 fold, at least 1.2 fold, at least 1.3 fold, at least 1.4 fold, at least 1.5 fold, at least 1.6 fold, at least 1.7 fold, at least 1.8 fold, at least 1.9 fold, at least 2 fold, at least 3 fold, at least 4 fold, at least 5 fold more resistant to oxidative degradation than a free bioactive agent not encapsulated by the minicell under UV or visible light exposure.

In other embodiments, the bioactive agent encapsulated by the minicell is at least 1.1 fold more resistant to oxidative degradation than a free bioactive agent not encapsulated by the minicell under UV or visible light exposure. In further embodiments, the bioactive agent encapsulated by the minicell is at least 1.1 fold more resistant to oxidative degradation than a free bioactive agent not encapsulated by the minicell on day 7 under UV or visible light exposure.

In some embodiments, the bioactive bioagent encapsulated by the minicell has less than about 90%, less than about 85%, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%,or less than about 10% oxidative degradation under UV or visible light exposure.

In other embodiments, the bioactive agent encapsulated by the minicell has less than about 35% oxidative degradation under UV or visible light exposure. In further embodiments, the bioactive agent encapsulated by the minicell has less than about 35% oxidative degradation on day 7 under UV or visible light exposure.

The present disclosure teaches that the minicell confers to the bioactive agent an improved stability, an enhanced bioavailability and an extended shelf life. The present disclosure teaches a composition comprising the minicell encapsulates the bioactive agent, thereby conferring to an improved stability, an enhanced bioavailability and an extended shelf life.

Release Of Bioactive Agents Encapsulated into AgriCell Platform

The present disclosure teaches a composition comprising: a minicell and a bioactive agent. In some embodiments, the bioactive agent is encapsulated by the minicell.

In some embodiments, a release of the bioactive agent encapsulated by the minicell is delayed when compared to a free bioactive agent not encapsulated by the minicell.

In some embodiments, a release percentage (%) of the encapsulated bioactive agent is less than about 90%, less than about 85%, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%,or less than about 10% after a release.

In some embodiments, a release percentage (%) of the encapsulated bioactive agent is less than about 50% in a first hour.

In some embodiments, a release percentage (%) of the encapsulated bioactive agent is at least about 45% at 8 hours after the release.

In some embodiments, the encapsulated bioactive agent has an extended release with less than about 90%, less than about 85%, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%,or less than about 10% of the bioactive agent retained, when compared to the non-encapsulated free bioactive agent that are fully released, at 8 hours after the release.

In some embodiments, the encapsulated bioactive agent has an extended release with less than about 50% of the bioactive agent retained, when compared to the non-encapsulated free bioactive agent that are fully released, at 8 hours after the release.

The present disclosure teaches that the AgriCell platform can be coated by biopolymer. The biopolymer is a chitosan. In some embodiments, the minicell is coated by biopolymer. In some embodiments, the biopolymer is a chitosan.

In some embodiments, a release of the bioactive agent encapsulated by the biopolymer-coated minicell is further delayed when compared to the encapsulated bioactive agent without the biopolymer coated.

In some embodiments, the bioactive agent encapsulated by the biopolymer-coated minicell has a further extended release with at least about 1%, at least about 5%, at least about 10%, at least about 20%, at least about 30%, at least about 40%, at least about 50%, at least about 60%, at least about 70%, at least about 80%, at least about 90% of the bioactive agent retained, when compared to the encapsulated bioactive agent without the biopolymer coated, after a release.

In some embodiments, the bioactive agent encapsulated by the biopolymer-coated minicell has a further extended release with at least about 10% of the bioactive agent retained, when compared to the encapsulated bioactive agent without the biopolymer coated, at 8 hours after the release.

In some embodiments, the bioactive agent encapsulated by the minicell is capable of being delivered to a target in a controlled release manner.

### Amounts of Bioactive Agents Delivered by AgriCell Platform

In some embodiments, bioactive agents are encapsulated within the minicells described herein and delivered to a desired subject. Amounts of bioactive agents of interest are provided herein with percent weight proportions of the various components used in the preparation of the minicell for the encapsulation and deliver of bioactive agents.

The percent weight proportions of the various components used in the preparation of the minicell for the encapsulation and deliver of bioactive agents can be varied as required to achieve optimal results. In some embodiments, the bioactive agents including, but are not limited to a nucleic acid, a polypeptide, a protein, an enzyme, an organic acid, an inorganic acid, a metabolite, an essential oil, a nutrient, and a semiochemical, are present in an amount of about 0.1 to about 99.9% by weight, about 1 to about 99% by weight, about 10 to about 90% by weight, about 20 to about 80% by weight, about 30 to about 70% by weight, about 40 to about 60% by weight, based on the total weight of the minicells within which a bioactive compound of interest is encapsulated. Alternate percent weight proportions are also envisioned.

Among the various aspects of the present disclosure is an minicell in the form of encapsulation of a bioactive agent of interest at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95%, by weight of the bioactive agent within the minicell.

In other embodiments, the bioactive agent within the minicell is present in an amount of at least about 0.01 g/L, at least about 0.02 g/L, at least about 0.03 g/L, at least about 0.04 g/L, at least about 0.05 g/L, at least about 0.06 g/L, at least about 0.07 g/L, at least about 0.08 g/L, at least about 0.09 g/L, at least about 0.1 g/L, at least about 0.2 g/L, at least about 0.3 g/L, at least about 0.4 g/L, at least about 0.5 g/L, at least about 0.6 g/L, at least about 0.7 g/L, at least about 0.8 g/L, at least about 0.9 g/L, at least about 1 g/L, about 2 g/L, at least about 3 g/L, at least about 4 g/L, at least about 5 g/L, at least about 6 g/L, at least about 7 g/L, at least about 8 g/L, at least about 9 g/L, at least about 10 g/L, at least about 11 g/L, at least about 12 g/L, at least about 13 g/L, at least about 14 g/L, at least about 15 g/L, at least about 16 g/L, at least about 17 g/L, at least about 18 g/L, at least about 19 g/L, at least about 20 g/L, at least about 30 g/L, at least about 40 g/L, at least about 50 g/L, at least about 60 g/L, at least about 70 g/L, at least about 80 g/L, at least about 90 g/L, at least about 100 g/L, at least about 110 g/L, at least about 120 g/L, at least about 130 g/L, at least about 140 g/L, at least about 150 g/L, at least about 160 g/L, at least about 170 g/L, at least about 180 g/L, at least about 190 g/L, at least about 200 g/L, at least about 300 g/L, at least about 400 g/L, at least about 500 g/L, at least about 600 g/L, at least about 700 g/L, at least about 800 g/L, at least about 900 g/L, or at least about 1000 g/L.

In another embodiment, the bioactive agent of interest and the minicell are present in compositions of the disclosure in a weight ratio of about 1:200, about 1:195, about 1:190, about 1:185, about 1:180, about 1:175, about 1:170, about 1:165, about 1:160, about 1:155, about 1:150, about 1:145, about 1:140, about 1:135, about 1:130, about 1:125, about 1:120, about 1:115, about 1:110, about 1:105, about 1:100, about 1:95, about 1:90, about 1:85, about 1:80, about 1:75, about 1:70, about 1:65, about 1:60, about 1:55, about 1:50, about 1:45, about 1:40, about 1:35, about 1:30, about 1:25, about 1:20, about 1:15, about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, about 10:1, about 15:1, about 20:1, about 25:1, about 30:1, about 35:1, about 40:1, about 45:1, about 50:1, about 55:1, about 60:1, about 65:1, about 70:1, about 75:1, about 80:1, about 85:1, about 90:1, about 95:1, about 100:1, about 110:1, about 115:1, about 120:1, about 125:1, about 130:1, about 135:1, about 140:1, about 145:1, about 150:1, about 155:1, about 160:1, about 165:1, about 170:1, about 175:1, about 180:1, about 185:1, about 190:1, about 195:1, or about 200:1. In another embodiment, the bioactive agent of interest and the minicell are present in a weight ratio of from about 1:50 to about 50:1, from about 1:40 to about 40:1, from about 1:30 to about 30:1, from about 1:20 to about 20:1, from about 1:10 to about 10:1, from about 1:5 to about 5:1, from about 1:4 to about 4:1, from about 1:3 to about 3:1, from about 1:2 to about 2:1 or from about 1 to about 1.

In some embodiments, a bioactive agent of interest, for example, is present in at least about 1%, at least about 5% at least about 10%, at least about 20%, at least about 30%, at least about 40%, at least about 50%, at least about 60%, at least about 70%, at least about 80%, at least about 90%, or at least about 95% of total mass of a formulated product. In further embodiments, about 10 to 90% of the total mass of the formulated product is provided for the bioactive agent disclosed herein and the remaining about 10 to 90% of the mass is from the minicell.

In some embodiments, more than one non-expressed bioactive agents can be encapsulated within the minicell. In another embodiment, the formulated product comprises two bioactive agents that are present in compositions of the disclosure in a weight ratio of about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, or about 10:1.

### Methods of Producing and Delivering Bioactive Agents to a Subject using AgriCell Platform

The present disclosure provides a method of preparing an minicell encapsulating a bioactive agent with fungicidal activity, said method comprising the steps of: a) producing and purifying minicells; b) providing a bioactive agent with fungicidal activity; c) loading the minicells with the bioactive agent for encapsulation; and d) recovering the minicells encapsulating the bioactive agent.

In some embodiments, in step a) the minicells are produced from a bacterial cell. In some embodiments, in step a) the purified minicells are provided as a suspension in water or other suitable liquid, or a concentrated paste. In some embodiments, the suspension comprises about 0.01 to 5,000 mg minicells per ml, about 0.1 to 3,000 mg minicells per ml, about 1 to 1,000 mg minicells per ml, or about 1 to 500 mg minicells per ml. In some embodiments, in step a) the purified minicells are provided as a dry powder.

In some embodiments, in step b) the bioactive agent provided as a suspension in an aqueous solvent.

In some embodiments, in step c) the loaded minicells are suspended in a suspension of the bioactive agent. In some embodiments, in step c) the reaction is carried out at atmospheric pressure at a temperature of about 1° C. to about 40° C., about 5° C. to about 40° C., about 10° C. to about 40° C., or about 20° C. to about 40° C. In some embodiments, in step c) the reaction is carried out at atmospheric pressure at a temperature of about 20° C. to about 37° C. In some embodiments, in step c) the loading ratio between the minicells and the bioactive agent is about 1:5 to about 5:1.

In some embodiments, the method described above further comprises the step of drying the minicells encapsulating the bioactive agent. In some embodiments, the drying of the minicells encapsulating the bioactive agent is by evaporating a solvent.

Among the methods of the present disclosure, the bioactive agent is a biologically active agent. In some embodiments, the biologically active agent is an essential oil.

The present disclosure provides a method of producing a compound for controlling fungi. In some embodiments, said method comprises applying to a locus said compound that comprises a minicell and a bioactive agent with fungicidal activity taught herein.

The present disclosure provides a method of enhancing health of a plant, said method comprising: administering to a plant in need thereof an fungicidally effective amount of a composition that comprises a minicell and a bioactive agent taught herein.

Among the methods of the present disclosure, the health of the plant applied with the composition is enhanced when compared to the health of the plant not administered with the composition. In some embodiments, the composition can be applied with other agricultural products. In some embodiments, other agricultural products can be fertilizers, weed killers, Cryoprotectants, surfactants, detergents, pesticidal soaps, dormant oils, polymers, and/or time-release or biodegradable carrier formulations. In further embodiments, other agricultural products can be also selective herbicides, chemical insecticides, virucides, microbicides, amoebicides, pesticides, fungicides, bacteriocides, nematocides, molluscicides or mixtures of several of these preparations, if desired, together with further agriculturally acceptable carriers, surfactants or application-promoting adjuvants customarily employed in the art of formulation..

The present disclosure provides a method of delivering a bioactive agent to a subject, the method comprising: applying to the subject with a composition that comprises a minicell and a bioactive agent taught herein. In some embodiments, the subject is a plant or environments around the plant. In some embodiments, the bioactive agent with fungicidal activity isan essential oil. In some embodiments, the bioactive agent has an fungicidal activity.

The present disclosure teaches a fungicidal composition and a method for controlling one or more fungi, the method comprising: applying an fungicidal composition to a locus. In embodiments of the composition and method of the present disclosure, said fungicidal composition comprising: (i) a minicell and (ii) a bioactive agent having fungicidal activity. In embodiments of the composition and method of the present disclosure, the bioactive agent is an essential oil. In embodiments of the composition and method of the present disclosure, the one or more fungi are controlled with application of said composition to a locus. In embodiments of the composition and method of the present disclosure, the minicell enhances stability and fungicidal activity of said bioactive agent in an environmental stress. In embodiments of the composition and method of the present disclosure, the minicell is an achromosomal bacterial cell. In embodiments of the composition and method of the present disclosure, the minicell is capable of encapsulating the bioactive agent. In embodiments of the composition and method of the present disclosure, the bioactive agent is present within the minicell. In embodiments of the composition and method of the present disclosure, said essential oil comprises an eugenol, a geraniol, or a thymol. In embodiments of the composition and method of the present disclosure, said essential oil is an eugenol. In embodiments of the composition and method of the present disclosure, said essential oil is a geraniol. In embodiments of the composition and method of the present disclosure, said essential oil is a thymol. In embodiments of the composition and method of the present disclosure, the minicell and the active agent are present in a weight-to-weight ratio of about 5:1 to about 1:5 in the composition. In embodiments of the composition and method of the present disclosure, the minicell and the active agent are present in a weight-to-weight ratio of about 1:1. In embodiments of the composition and method of the present disclosure, the minicell is less than or equal tol p.m in diameter.

In embodiments of the composition and method of the present disclosure, the locus is a plant, a plant part thereof, or soil on which the plant grows or is supposed to grow. In embodiments of the composition and method of the present disclosure, the locus is one or more fungi or fungal-like microorganisms. In embodiments of the composition and method of the present disclosure, the locus is one or more fungi or fungal-like microorganisms. In embodiments of the composition and method of the present disclosure, said application of the method improves growth in one or more crops. In embodiments of the composition and method of the present disclosure, said improved growth is selected from the group consisting of preventively and/or curatively controlling pathogenic fungi and/or nematodes, resistance management, and improved plant physiology effects selected from enhanced root growth, improved greening, improved water use efficiency, improved nitrogen-use efficiency, delayed senescence and enhanced yield. In embodiments of the composition and method of the present disclosure, said environmental stress is temperature at 37° C. or higher. In embodiments of the composition and method of the present disclosure, the bioactive agent in the presence of the minicell has at least 1% higher fungicidal activity than the bioactive agent alone 24 hours after treatment of said composition. In embodiments of the composition and method of the present disclosure, said method further comprises a surfactant. In embodiments of the composition and method of the present disclosure, the composition is applied in a liquid form or a soluble, dry powder form.

The present disclosure provides that essential oils are considered to be an environmentally friendly alternative to chemical fungicides, but they tend to be expensive, volatile, and phytotoxic. The application of AgriCell-EOs has resulted in improved efficacy leading to lower required doses (lower costs), reduced phytotoxicity, and reduced toxicity. AgriCell-EOs can be further enhanced by being coated by plant immunity boosters such as Chitosan.

Due to the high sensitivity of EOs to temperature, pH, and other factors, they need to be encapsulated to ensure stability and consistency of the bioactive components of phytobiotics and programmed release in the environment. Evaluation of existent literature data on essential oil stability revealed that oxidative changes and deterioration reactions, which may lead to both sensory as well as pharmacologically relevant alterations, have scarcely been systematically addressed.

AgriCell platform has proven to protect essential oils and ensure their delivery to the harsh environment. Without proper protection, most topically sprayed essential oils may not reach the intended pathogen. Consequently, the use of AgriCell platform provides improved performance in terms of chemical stability under environmental conditions, better protection to autoxidative processes during storage, and improving bioavailability through an encapsulation and controlled release mechanism.

AgriCell platform has proven to protect essential oils and ensure their delivery to a locus of the present disclosure. Without proper protection, most topically applied essential oils may not reach the intended fungal or fungal-like pests. Consequently, the use of AgriCell platform provides improved performance in terms of chemical stability under harsh environmental conditions, better protection to autoxidative processes during storage, and improving bioavailability through an encapsulation and controlled release mechanism.

### EXAMPLES

The following examples are given for the purpose of illustrating various embodiments of the disclosure and are not meant to limit the present disclosure in any fashion. Changes therein and other uses which are encompassed within the spirit of the disclosure, as defined by the scope of the claims, will occur to those skilled in the art.

### Example 1. Production and Characterization of AgriCell (Minicell) Platform

A minimal media fermentation and a two-step centrifugation process constitute the manufacturing process for AgriCell production and purification. The entire process takes approximately 36 hours to produce and recover 20-50 grams dry mass of AgriCells per liter of fermentation broth. Pure AgriCells were concentrated in PBS using centrifugation and then frozen at −80° C. Samples were then sealed inside the LabConco FreeZone Plus 6 system and lyophilized overnight at a chamber temperature of −90° C. and pressure of 133×10⁻³ mBar.

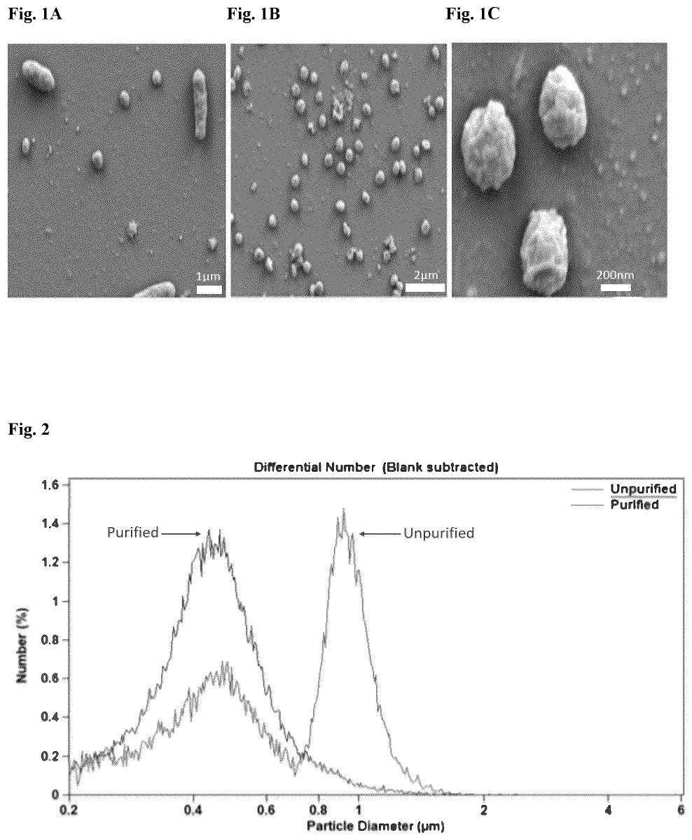

An E. coli strain was taken and designed for a fermentation process to robustly produce AgriCells. A downstream process was developed to rapidly and effectively purify the bacterial minicells from the viable, whole parental cells. FIGS. 1A-1C shows scanning electron microscopy (SEM) images of the whole, rod-shaped cells (FIG. 1A) and smaller, spherical AgriCells after a fermentation and purification process (FIGS. 1B-1C). All images were taken with the Zeiss Sigma VP HD field emission SEM in secondary electron imaging mode.

The efficacy of a differential centrifugation protocol developed by inventors is further demonstrated in FIG. 2, which shows a size distribution profile of AgriCell producing cell line. The profile was generated using the Multisizer 4E Coulter Counter which detects and characterizes particles using electrical zone sensing. The small, anucleate AgriCells, which purified to a degree of more than 99% purity, are then taken for next step for the encapsulation of active ingredients/agents.

### Example 2. Encapsulation of Essential Oils (EOs) into AgriCell Platform

### (1) Selection of Essential Oils (EOs)

Three active ingredients of model EOs were selected for encapsulation and efficacy studies on AgriCell. Eugenol (99% purity, extracted from clove oil, Sigma Aldrich Lot# STBJ0145), thymol (98.5% purity, extracted from thyme oil, Sigma Aldrich Lot# SLCF3572) and geraniol (98% purity, Sigma Aldrich Lot# SHBL9235) were prepared.

### (2) Loading Process

Eugenol, geraniol and thymol were selected as model EOs for encapsulation experiments.

After AgriCells are purified, the concentrated AgriCell paste or dry lyophilized powder is loaded with EOs. If dry, the AgriCells are first homogenized into a finer powder through mechanical homogenization. A stock solution from each EO is prepared in ethanol at 100 mg/mL-200 mg/mL. Lyophilized AgriCells would then be suspended in a solution with the EO solution at a ratio of 1 g of dry AgriCells to 10 mL of EO solution. Once resuspended, the ethanol is allowed to evaporate overnight, leaving behind EO encapsulated AgriCells in the process. After this overnight period, encapsulated AgriCells are removed from the beaker, and the EO-encapsulated AgriCell powder is mechanically homogenized. This encapsulated product is ready for resuspension in its appropriate medium. Loading efficacy was measured and/or calculated as percentage of EO loaded into AgriCell after extraction with ethanol 100% v/v and quantification by UV-Vis spectroscopy. Eugenol, geraniol and thymol were quantified at 280 nm.

Encapsulation of Active Ingredients/Agents of EOs into AgriCell Platform

The active ingredients/agents of model essential oils (i.e. eugenol, geraniol, thymol) were efficiently encapsulated into AgriCell platform, via passive diffusion - concentration reduction mechanism.

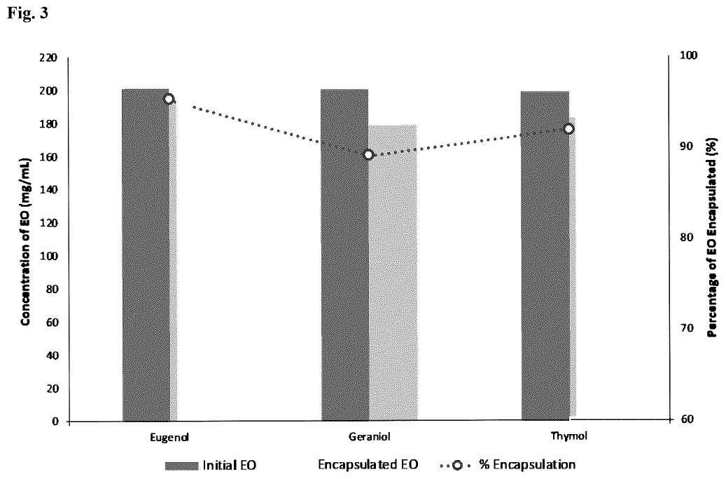

FIG. 3 shows the results for encapsulation efficacy of eugenol, thymol, and geraniol, and the final concentrations of EOs encapsulated into the AgriCell. Results indicate all model essential oils showed good yields for encapsulation, with eugenol showing the highest encapsulation efficacy (95.5%), followed by thymol (91.8%) and geraniol (89.0%). All formulations showed optimal stability and were easy to handle.

### Example 3. Stability of Essential Oils (EOs) encapsulated into AgriCell platform

### (1) Improved Chemical Stability of EOs to Changes in pH

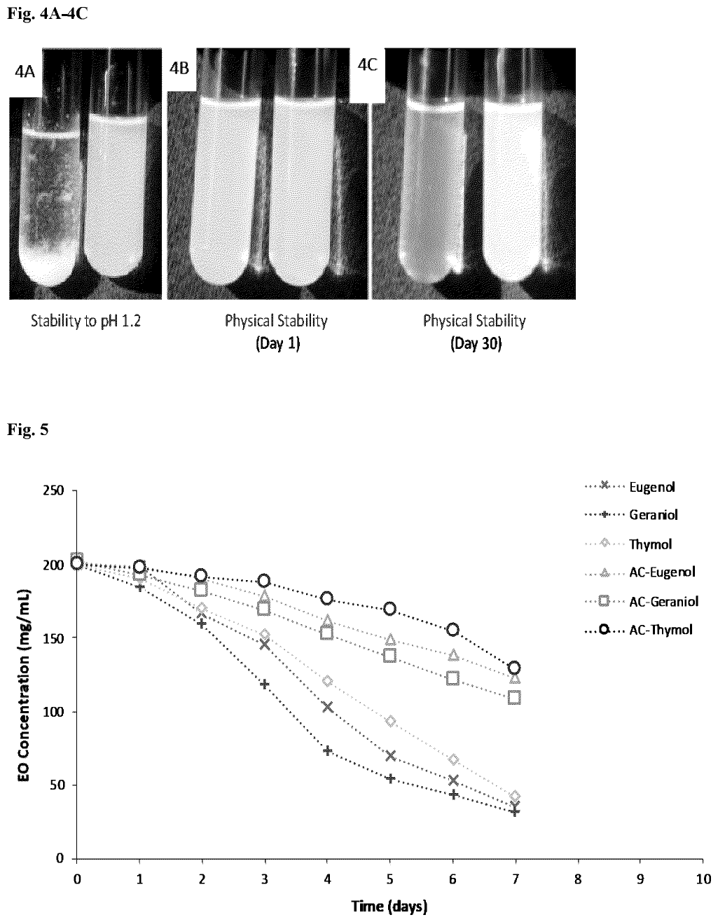

For illustrative purposes, FIGS. 4A-4C shows the physical stability of the model formulation composed by eugenol encapsulated AgriCell, when compared to a standard liposomal formulation encapsulating eugenol, using soybean lecithin and cholesterol. FIG. 4A illustrates AgriCell encapsulating eugenol (right tube), which shows improved chemical stability to changes in pH, when compared to Eugenol-encapsulating liposomal formulation (left tube). AgriCell-encapsulated eugenol showed improved stability when pH was adjusted to simulate gastric conditions (pH 1.2). FIG.S 4B-4C illustrates the improved physical stability of AgriCell-encapsulated eugenol (right tube) against a Eugenol-encapsulated liposomal formulation (left tube) on day 1 (FIG. 4B) and day 30 (FIG. 4C) after storage under controlled conditions (temperature 25° C., relative humidity 30% and pH 7.2). All samples were diluted 1:10 with deionized water.

Results present that AgriCell platform succeeded in stabilizing the encapsulated EO (e.g. eugenol) when compared to a standard liposomal formulation, showing better stability to changes in pH (FIG. 4A) and under controlled storage conditions (temperature 25° C., relative humidity 30% and pH 7.2; FIGS. 4B-4C).

As shown in FIG. 4A, the EO-encapsulated liposomes suffered depletion flocculation processes when submitted to changes in pH 1.2 simulating gastric conditions, depicting in immediate release of encapsulated EO and poor bioavailability without desired nutritional effects. As shown in FIGS. 4B-4C, the same liposomal formulation lacked long term stability and the formulation experienced significant degradation after 30 days storage under controlled conditions.

Thus, results indicate that AgriCell succeeded in providing improved stability, higher bioavailability and extended shelf life for encapsulated EOs.

### (2) Improved Thermal Stability of EOs

AgriCell-encapsulated EOs, which were AC-Eugenol, AC-Geraniol, and AC-Thymol, (200 mg/mL of EO loaded with 200 mg/mL of AgriCell) were diluted 1:10 in deionized water (total volume 1000 μL, 14 replicates for each EO) and the solutions were left at 40° C. for a total period of 7 days. One replicate of each EO per treatment was collected daily and tested for EO content. Results were reported as concentration of EO as function of time for each stability condition.

Ambient temperature crucially influences essential oil stability in several respects. Generally, chemical reactions accelerate with increasing heat due to the temperature-dependence of the reaction rate as expressed by the Arrhenius equation. Based thereon, the van't Hoff law states that a temperature rise of 10° C. approximately doubles chemical reaction rates, a relation that can be consulted to predict stability at different temperatures (Glasl, 1975). Hence, both autoxidation as well as decomposition of hydroperoxides advances with increasing temperature, even more so since heat is likely to contribute to the initial formation of free radicals (Choe and Min, 2006).

FIG. 5 shows the performance of AgriCell in preventing thermal degradation of model EOs. Results support the improvement in EO's thermal stability when encapsulated into AgriCell. The trends in FIG. 5 shows that free geraniol experienced the highest sensitivity to temperature raise, followed by free eugenol and lastly free thymol, reaching percentages of degradation after day 7 of 84.2% (free geraniol), 82.6% (free eugenol) and 79.1% (free thymol), respectively. The same trends were seen in the AgriCell encapsulated formulations, but the percentages of degradation were significantly improved in about 45%, with AgriCell-encapsulated geraniol, eugenol and thymol yielding to percentages of degradation of 46.0%, 38.9% and 35.6% at day 7 of the stability experiment.

### (3) Improved Oxidative Stability of EOs

Ultraviolet (UV) light and visible (Vis) light are considered to accelerate autoxidation processes by triggering the hydrogen abstraction that results in the formation of alkyl radicals. Compositional changes proceeded considerably faster when illumination is involved. Especially monoterpenes have been shown to degrade rapidly under the influence of light (Turek and Stintzing, 2013). Essential oils experiences accelerated autoxidative reactions when exposed to UV or light radiation, which triggers hydrogen abstraction that results in the formation of alkyl radicals (Turek and Stintzin 2013).

AgriCell-encapsulated EOs, which were AC-Eugenol, AC-Geraniol, and AC-Thymol, (200 mg/mL of EO loaded with 200 mg/mL of AgriCell) were diluted 1:10 in deionized water (total volume 1000 μL, 14 replicates for each EO) and the solutions were left under UV radiation for a total period of 7 days. One replicate of each EO per treatment was collected daily and tested for EO content by UV-Vis spectroscopy as described in Example 2. Results were reported as concentration of EO as function of time for each stability condition.

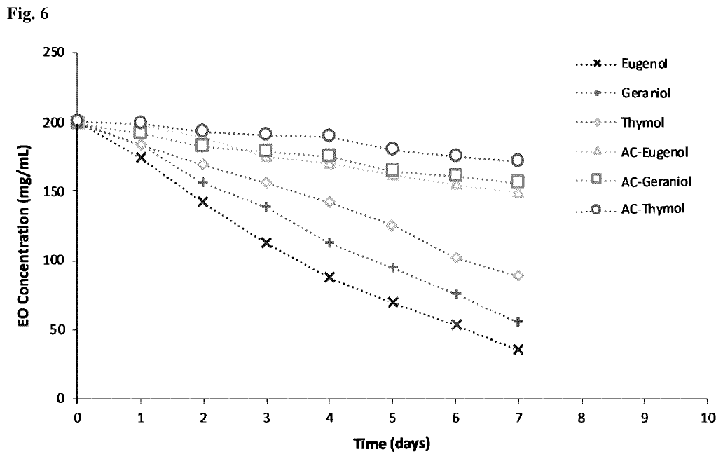

FIG. 6 shows the performance of AgriCell in preventing oxidative degradation of model EOs by influence of UV and Vis light. Results support the improvement in EO's oxidative stability when encapsulated into AgriCell. The trends in FIG. 6 show that free geraniol and eugenol experienced the highest oxidative rate, whereas free thymol showed lower tendency to oxidation. After 7 days of stability experiments, the oxidative processes yielded reduction of 82.6%, 72.6% and 55.8% for eugenol, geraniol and thymol, respectively. However, after 7 days of stability experiments, degradation rates for the model essential oils encapsulated into AgriCell were 25.9%, 21.5% and 14.1% for eugenol, geraniol and thymol, respectively (i.e. 74.1%, 79.5% and 85.9% of eugenol, geraniol and thymol, respectively remained/not damaged). This is corresponding to an improvement of about 50% for all the encapsulated formulations over free EO formulations, supporting the protective effect of AgriCell encapsulation on autoxidation of essential oils. The results in FIG. 6 shows the effect AgriCell encapsulation on preventing autoxidative degradation of essential oils.

These results support the potential improvement in shelf-life properties for encapsulated AgriCell containing sensitive bioactive ingredients.

### Example 4. Controlled Release of Essential Oils (EOs) Encapsulated into AgriCell Platform

### (1) Chitosan Coating Process to Modify AgriCell Controlled Release Properties

AgriCell-encapsulated EO (AgriCell-EO) formulations can then be further modified for its release properties. Surface coating technique via ionotropic gelation mechanism was used to generate a unique AgriCell-EO formulation, composed by an EO encapsulated by AgriCell that is coated by chitosan biopolymer (AgriCell-EO CHT).

Existing studies have shown that to optimize the characteristics and stability of carriers which can be coated by a biopolymer, by means of electrostatic interactions providing a dense polymeric shell around the carriers that will promote stabilization and prevent leaking of active ingredient to external compartments (Filipoviĉ-Grcic et al. 2007, Mengoni et al. 2017). In this example, AgriCell platform was coated by chitosan through ionic gelation reaction due to electrostatic interactions between the negatively charged AgriCell surface and the positive charges of primary amino groups in chitosan, similar to previously described for chitosan coated liposomes (Madrigal-Carballo et al. 2009, 2010). Chitosan solution, in acetic acid, was mixed with AgriCell platform, dispersed in PBS (1×, pH 7.4) and previously loaded with EOs (eugenol and thymol), under continuous stirring for 1 hour at room temperature, yielding chitosan coated AgriCell-EO that were purified by centrifugation (12,000 rpm) and stored at 4° C. until further experimentation.

(2) Controlled Release of EOs from AgriCell and AgriCell-CHT

EOs-loaded AgriCell formulations (with and without chitosan surface coating) were prepared in PBS (1×, pH 7.4) and diluted to a known concentration in release media composed by PBS, ethanol and Tween 80 emulsifier (140:59:1 v/v/v). Samples (500 μL) were loaded into dialysis cassettes (MWCO 8-10 kDa) pre stabilized in deionized water, place into a reservoir container filled with exactly 100 mL of release media and kept under gentle stirring at room temperature. At different time intervals, an aliquot (1000 μL) of release media was removed for quantification of released EOs in ethanol (100%v/v) performed by UV-vis spectrometry as described above, a new volume of fresh release media was added to continue release experiments. EOs released from AgriCell platform were observed as percentage cumulative release over the selected timeframe. Original content of EOs loaded into AgriCell and the remained content after release studies were quantified by solvent extraction with ethanol (100% v/v) directly from AgriCell.

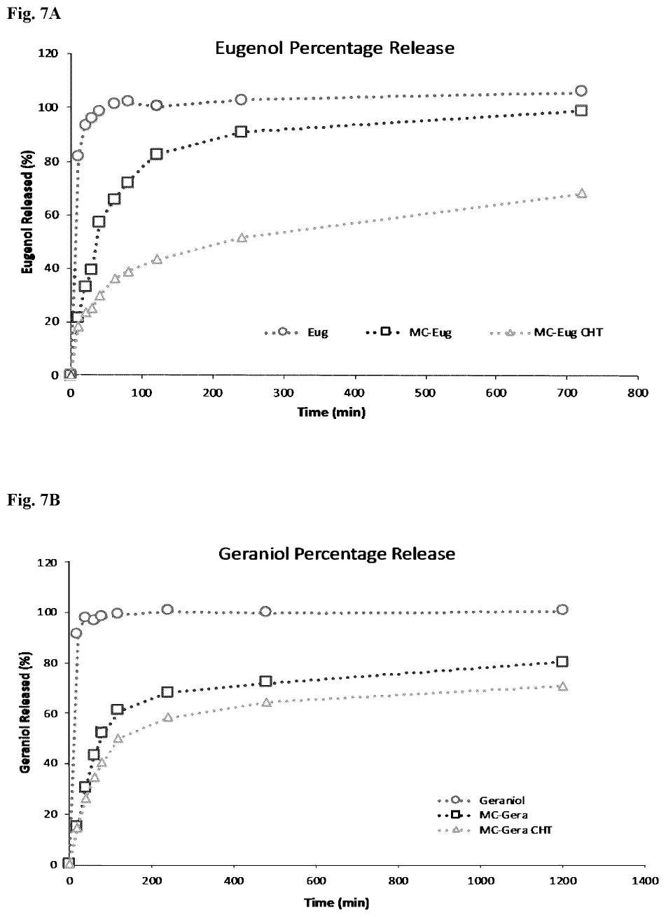

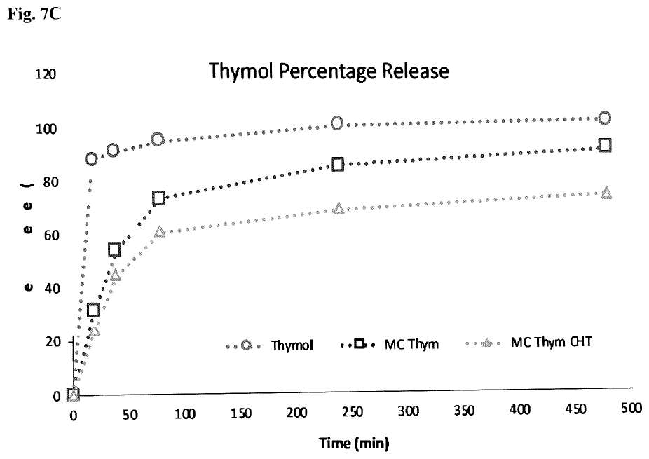

The cumulative release profile of model EOs was calculated by determining the concentration of each EO in the release medium at different times. FIGS. 7A-7C shows the release profiles for eugenol (FIG. 7A), geraniol (FIG. 7B) and thymol (FIG. 7C) loaded into AgriCell formulations, respectively. Results indicate AgriCell platform can efficiently delay burst release stage of EOs, as suggested by the significant reduction in the percentage of each EO released in the first hour of the release experiments, where all encapsulated EOs showed percentages of release lower than 40%, whereas free EOs have reached close to 90% release in the same timeframe.

After completion of release studies, AgriCell encapsulated EOs reached a percentage release of 98.5%, 79.0% and 90.1% for eugenol, geraniol and thymol, respectively, as shown in FIGS. 7A-7C. Similar behavior was observed for the treated AgriCell systems surface coated by chitosan biopolymer (CHT), but the CHT coated systems showing a more efficient delaying effect on release of EOs when compared to AgriCell non-coated, yielding to final percentages of release at the end of the experiment of 67.8%, 58.3% and 73.0% foe eugenol, geraniol and thymol, respectively. In average, chitosan coating of AgriCell was able to improve controlled release of encapsulated EOS in about 20% for all model EOs tested.

### Example 5. Biofungicide Plate Efficacy Testing

Encapsulated Oils were tested at three concentrations (100×, 1000×, 10,000×) against Botrytis cinerea. Botrytis cinerea causes serious gray mold disease in many plants. Hou et al. (2020) reported that Essential oils (EOs) from Origanum vulgare essential oil (OVEO) showed strong antifungal activity.

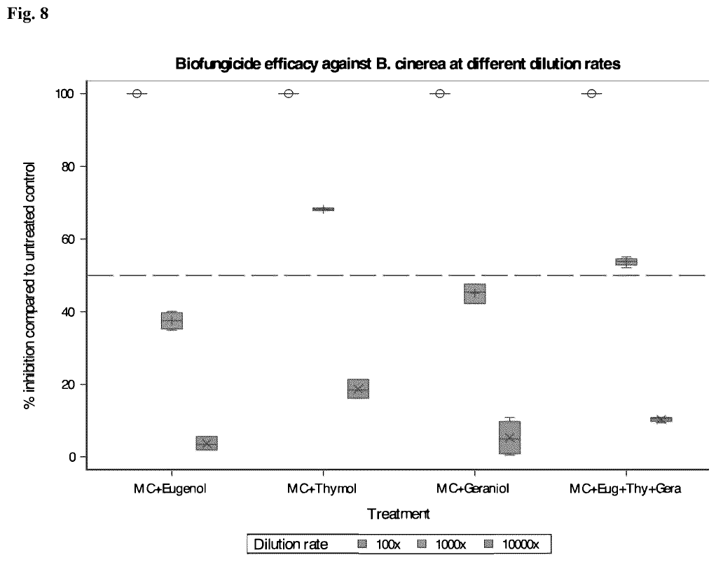

FIG. 8 illustrates biofungicide efficacy against Botrytis cinerea at different dilution rates (100×, 1000×, 10,000× dilutions). The tested biofungicides are essential oils (EOs); MC+Eugenol (Eugenol encapsulated by minicell), MC+Thymol (Thymol encapsulated by minicell), MC+Geraniol (Geraniol encapsulated by minicell), and MC+Eug+Thy+Gera (Eugenol:Thymol:Geraniol encapsulated by minicell). Percent (%) inhibition of B. cinerea for each of minicell-encapsulated EO biofungicides was presented in comparison to free EO biofungicide controls without minicell treated/encapsulated.

The reported EC50 values (i.e. a measure of concentration) for Thymol against B. cinerea, is 21.32 ug/ml. With an EC50 value of 16.8 ug/ml for MC+Thymol, the AgriCell platform demonstrates an improvement in the activity of Thymol after encapsulation.

### Example 6. Enhanced Thermal Stability of AC-encapsulated Biofungicide

Plant oils such as Thyme oil (Active Ingredient: Thymol) are effective biofungicides with known limitations of volatility and instability resulting in limited field life. The thermal stability of biofungicide was tested between AC-encapsulated vs AC-upcapsulated biofungicides (i.e. AC-Thymol vs Free Thymol).

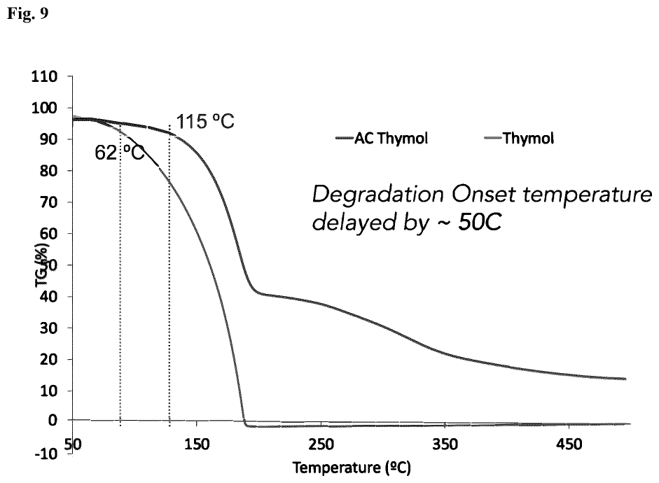

FIG. 9 illustrates thermogravimetric Analysis (“TGA”) between AgriCell encapsulated Thymol (“AC Thymol”) and free Thymol (“Thymol”; not encapsulated by AgriCell) along with gradual increase of temperature from 37° C. to 500° C.

The stability/volatility profile is evidenced by the accelerated degradation of free Thymol starting at about 62° C. as depicted in FIG. 9. AgriCell encapsulation stabilizes the Thymol by about 50° C. or higher, delaying the degradation onset and stabilizing the Thymol to high temperature exposures.

### Example 7. Protection of Plants from Phytotoxicity by AgriCell Encapsulation

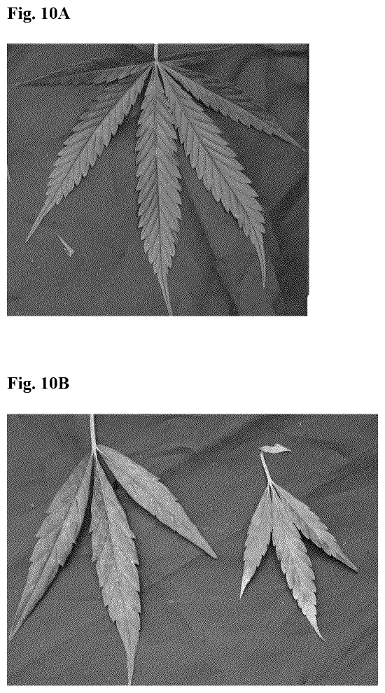

FIG. 10A shows phytotoxicity of AgriCell-encapsulated biofungicide (AC-Thyme) on Hemp leaf, while FIG. 10B shows phytotoxicity testing of unencapsulated biofungicide (AC-Thyme) for Hemp leaves. Thyme Oil applied at same AI rate with and without encapsulation. AgriCell encapsulated Thyme Oil displays good plant health, while Free Thyme Oil causes extensive phytotoxicity.

### Example 8. AgriCell-Biofungicide Greenhouse Testing in Hemp Powdery Mildew (PM)

To Investigate efficacy of AgriCell-Thyme compared to commercial standards applied on a weekly spray cycle, AgriCell-Thyme was tested as an extended protectant and curative treatment.

The experimental design was a randomized complete block design with four replications. Each treatment was tested on four replicated plants. The entire experiment was performed 3 times. Application Rate was 0.25-1% (32-128 fl oz per 100 GPA). Plants rated for PM incidence and severity weekly beginning 7 days after inoculation.

Disease incidence was rated as the percentage of leaves with at least one powdery mildew lesion, and severity will be rated as the average diseased area of leaves with at least one powdery mildew lesion. Disease index will be calculated based on the following formula. DI=(I*S)/100, where DI=disease index, I=disease incidence, S=disease severity, and 100 represents the maximum possible incidence and severity scores. The Turkey HSD Test was be utilized to determine statistically significant differences between treatment groups. Means followed by the same letter(s) within columns are not significantly different.

AgriCell-Thymol provides complete control against Powdery Mildew and is superior in performance to listed commercial products included in this trial. Also, AgriCell-Thymol offers extended protectant efficacy and curative control. AgriCell-Thymol performance is enhanced by adjuvants. Importantly, AgriCell-Thyme applied between 0.5-1% v/v as a protectant, extended protectant or curative fungicide provided equivalent or superior control to all other products applied as protectant treatments, with no phytotoxicity.

### Example 9. AgriCell BioFungicide Performance as Rotational/Tank-Mix in Strawberry Field Trials

Biorational products alone or in combination with conventional fungicide treatments were evaluated for Botrytis fruit rot (BFR) and Pestalotia fruit rot management at a commercial farm in Plant City, FL. Bare-root transplants from a nursery in Canada were planted into raised beds covered with black plastic mulch. Beds were previously fumigated with Pic-Clor 80 (200 lb/A) and measured 28 in. wide on 4-ft centers. Twelve plants per plot were spaced 16 in. apart within and between rows, and each plot measured 10-ft long separated by a 4-ft gap. Plants were established using overhead irrigation for ten days, and water and fertilizers were delivered by drip tape throughout the entire season. Twenty-three biorational and conventional fungicide treatments and a non-treated control were arranged in a randomized complete block design with four blocks as replications. Treatments were applied with a CO₂ back-pack sprayer calibrated to deliver 100 gal/A at 60 psi through two hollow-cone T-Jet 8002 nozzles spaced 12-in. apart on the wand. Ten treatments consisted of weekly applications of biorational products that were made 14 times. Treatment programs with the conventional fungicide Switch 62.5WG were applied during weeks of conducive weather for infection (17 to 25° C. and ≥12 h leaf wetness), following risk assessments by the Strawberry Advisory System (StAS, http://sas.agroclimate.org). Captan Gold 80WDG, Biofungicide 1 (BFun1), Biofungicide 2 (BFun2), SA 0650004, Exp 14, or BW165E were applied in alternation with Switch 62.5WG during weeks with low disease risk. Some treatments consisted of biorational products BFun1, BFun2, Exp 14, or ProBlad Verde applied in alternation with Captan Gold 80WDG when disease risk was low. In total, five StAS-based applications were made. Twenty-one harvests were made. Fruit were usually harvested twice a week to determine yield and fruit rot incidences caused naturally by Botrytis cinerea and Neopestalotiopsis spp. Marketable fruit were counted and weighed to determine yield, and disease incidences were expressed as a percentage of the total number of marketable and non-marketable fruit. All data were analyzed by fitting a generalized linear mixed model using the statistical software SAS and means were separated using Fisher's Protected LSD test (α=0.05).

During the trial, StAS identified 14 and 6 days that were moderately and highly conducive for disease development, respectively. The disease alerts occurred during early and late season indicating conditions were suitable for infection throughout the strawberry season. Thus, average disease incidence for the entire season is reported. In the non-treated control (NTC), BFR incidence averaged 15.8%. The treatments including SA 0650004 at 28 and 42 fl oz, Serenade Opti, PREY-AM, Exp 14 at 7.14 oz applied weekly, and BFun2 and ProBlad Verde alternated with Captan Gold 80WDG or Serenade Opti failed to reduce BFR incidence compared to the NTC. The most effective treatments all included Switch 62.5WG alternated with BFun1, BFun2, SA 0650004, Captan Gold 80WDG, Exp 14, or BW165E. During the season, Pestalotia fruit rot was observed in the trial with an average of 19.8% in the non-treated control. Treatments including Switch 62.5WG alternated with Captan Gold 80WDG, BW165E, Exp 14, BFun1, or SA 0650004, as well as Exp 14 at 10.72 oz and BFun1 and BFun2 alternated with Captan Gold 80WDG significantly reduced disease incidence. For the overall season, Switch 62.5WG alternated with Captan Gold 80WDG, Exp 14, BW165E, BFun1, Bfun2, or SA 0650004, as well as Exp 14 and BFun1 alternated with Captan Gold 80WDG, and Exp 14 7.14 oz applied weekly significantly increased yield compared to the non-treated control. No phytotoxicity was observed in this trial.

TABLE 1
Results of biorational products in combination
with biofungicides (BFun1 and BFun2)

| | | | Disease incidence | |
|---|---|---|---|---|
| | | | (%)^{x} | |
| Treatment (products | Application | Yield | Pestalotia | Botrytis |
| and rates/A) | timing^{z} | (lb/A)^{y} | fruit rot | fruit rot |
| Switch 62.5WG 14 oz | 4, 7, 10, 12, 13 | 23576 | 8.2 | 3.0 j |
| BFun1 1% + Induce 1 pt | 1, 2, 3, 5, 6, 8, | abcd | efg | |
| | 9, 11, 14 | | | |
| Switch 62.5WG 14 oz | 4, 7, 10, 12, 13 | 21714 | 8.6 | 3.5 j |
| SA 0650004 28 fl oz + | 1, 2, 3, 5, 6, 8, | bcde | efg | |
| Induce 1 pt | 9, 11, 14 | | | |
| Switch 62.5WG 14 oz | 4, 7, 10, 12, 13 | 22438 | 13.4 | 3.7 j |
| BFun2 2% + Induce 1 pt | 1, 2, 3, 5, 6, 8, | abcde | bcde | |
| | 9, 11, 14 | | | |
| Switch 62.5WG 14 oz | 4, 7, 10, 12, 13 | 25698 | 8.1 | 4.2 |
| Exp 14 7.14 oz | 1, 2, 3, 5, 6, 8, | ab | efg | ij |
| | 9, 11, 14 | | | |
| Switch 62.5WG 14 oz | 4, 7, 10, 12, 13 | 26439 a | 5.1 g | 4.2 |
| Captan Gold 80WDG | 1, 2, 3, 5, 6, 8, | | | hij |
| 1.9 lb | 9, 11, 14 | | | |
| Switch 62.5WG 14 oz | 4, 7, 10, 12, 13 | 25517 | 10.6 | 4.2 |
| Exp 14 10.72 oz | 1, 2, 3, 5, 6, 8, | ab | cde | hij |
| | 9, 11, 14 | | | |
| Switch 62.5WG 14 oz | 4, 7, 10, 12, 13 | 23729 | 5.9 | 4.4 |
| BW165E WP 3 lb + | 1, 2, 3, 5, 6, 8, | abcd | fg | hij |
| Kinetic 0.1% | 9, 11, 14 | | | |
| Exp 14 7.14 oz | 4, 7, 10, 12, 13 | 21464 | 12.5 | 6.4 |
| Captan Gold 80WDG | 1, 2, 3, 5, 6, 8, | bcde | bcde | ghi |
| 1.9 lb | 9, 11, 14 | | | |
| Exp 14 10.72 oz | 4, 7, 10, 12, 13 | 23802 | 10.6 | 6.7 |
| Captan Gold 80WDG | 1, 2, 3, 5, 6, 8, | abc | cdef | fgh |
| 1.9 lb | 9, 11, 14 | | | |
| BW165E WP 3 lb + | weekly | 16681 | 17.9 | 6.8 |
| Kinetic 0.1% | | fghi | abc | fghi |
| BFun1 1% + Induce 1 pt | 4, 7, 10, 12, 13 | 23268 | 9.1 | 8.0 |
| Captan Gold 80WDG | 1, 2, 3, 5, 6, 8, | abcde | efg | efg |
| 1.9 lb | 9, 11, 14 | | | |
| BW900N 3 lb + | weekly | 19223 | 19.3 | 8.8 |
| Kinetic 0.1% | | defghi | ab | defg |
| Oso 5% SC 6.5 oz + | weekly | 15990 | 24.1 a | 9.7 |
| Nu-Film P 4 fl oz | | ghi | | defg |
| OR278 8 pt + OR159 | weekly | 18888 | 19.4 | 10.1 |
| 1% 8 pt | | efghi | ab | cdef |
| Exp 14 10.72 oz | weekly | 16904 | 16.6 | 10.9 |
| | | fghi | abcd | cde |
| SA 0650004 42 fl oz + | weekly | 14778 i | 21.2 | 10.9 |
| Induce 1 pt | | | ab | bcde |
| BFun2 2% + Induce 1 pt | 4, 7, 10, 12, 13 | 20496 | 10.2 | 11.1 |
| Captan Gold 80WDG | 1, 2, 3, 5, 6, 8, | cdefg | def | bcde |
| 1.9 lb | 9, 11, 14 | | | |
| Serenade Opti 1 lb | weekly | 19955 | 19.5 | 11.4 |
| | | cdefgh | ab | bcde |
| ProBlad Verde 32 fl oz | 4, 7, 10, 12, 13 | 18910 | 23.6 a | 11.6 |
| Serenade Opti 1 lb other | 1, 2, 3, 5, 6, 8, | efghi | | bcde |
| weeks | 9, 11, 14 | | | |
| PREV-AM 3.2 pt | weekly | 15822 | 19.4 | 12.1 |
| | | hi | ab | abcde |
| Exp 14 7.14 oz | weekly | 20839 | 13.2 | 13.2 |
| | | cdef | bcde | abcd |
| SA 0650004 28 fl oz + | weekly | 15307 i | 18.2 | 14.3 |
| Induce 1 pt | | | ab | abc |
| Non-treated control | — | 15973 | 19.8 | 15.8 |
| | | ghi | ab | ab |
| ProBlad Verde 45.7 fl oz | 4, 7, 10, 12, 13 | 16912 | 22.0 a | 17.2 a |
| Serenade Opti 1 lb | 1, 2, 3, 5, 6, 8, | fghi | | |
| | 9, 11, 14 | | | |
| Probability of a greater F | | <0.0001 | <0.0001 | <0.0001 |
| value | | | | |

^{z}Week of application over 14 weeks.
^{y}Yield based on harvest data (21 harvests total).
^{x}Average of Pestalotia and Botrytis fruit rots incidence for 3 months (whole season).
^{w} Values in a column followed by the same letter are not significantly different by Fisher's Protected LSD test (α = 0.05).

### Example 10. AgriCell Biofungicide for Protection of Grapes Against Fungi

Trials were conducted to test protection against Powdery mildew on grapes.

TABLE 2

| Treatment | Prevalence % | Severity % |
|---|---|---|
| EXP2 128 fl oz + Dynamic | 6.0 | 0.550 |
| 0.125% v/v (7 d) | | |
| Untreated Control | 71.0 | 46.13 |

Trials were conducted to test protection against Bunch rot on grapes:

TABLE 3

| Treatment | Mean incidence % | Mean Severity % |
|---|---|---|
| Fungicide Thyme 128 fl oz + | 16 | 1.46 |
| Dynamic 0.125% v/v | | |
| Untreated Control | 44 | 7.34 |

### Example 11. AgriCell Biofungicide for Protection of Wheat Crop Against Fusarium graminearum

Trial was conducted to test protection of wheat crop against Fusarium graminearum and incidence of Fusarium Head Blight (FHB) of wheat.

TABLE 4

| | Leaf | Leaf | Average | | |
|---|---|---|---|---|---|
| | blotch | blotch | FHB | FHB | FHB |
| | severity | Incidence | severity | Incidence | Index |
| Treatment | % | % | % | % | (0-100) |
| Untreated | 4.2 | 100 | 4.4 | 5.0 | 0.35 |
| Tebuconazole | 3.8 | 100 | 1.5 | 2.5 | 0.08 |
| (Folicur) | | | | | |
| AC | 3.5 | 100 | 4.7 | 7.5 | 0.38 |
| Biofungicide | | | | | |
| Chitosan high | | | | | |
| Tebuconazole | 3.6 | 100 | 8.3 | 4.2 | 0.48 |
| (Folicur) | | | | | |

### Example 12. AgriCell Biofungicide for Prevention of Disease on Several Ornamentals in the Field Trial was conducted to test prevention of disease on several ornamentals in the field.

TABLE 5

| | % Disease after the Final Treatment | | | |
|---|---|---|---|---|
| | | | Rose (older | Rose (new |
| Sample | Daylily | Hawthorn | growth) | growth) |
| Non treated check | 16.0 | 5.0 | 30.0 | 20.0 |
| AGR- FunThyme 0.5% | 8.0 | 7.5 | 26.7 | 11.7 |
| AGR- FunThyme 1% | 13.0 | 5.0 | 23.3 | 12.7 |
| AGR- FunThyme 0.5% + | 12.0 | 11.3 | 13.3 | 6.7 |
| Tween20 0.2% | | | | |
| AGR- FunThyme 1% + | 16.0 | 8.8 | 13.3 | 6.7 |
| Tween20 0.2% | | | | |
| AGR- FunOil 0.5% | 9.0 | 5.0 | 20.0 | 6.7 |
| AGR- FunOil 1% | 11.0 | 8.8 | 20.0 | 11.7 |
| AGR- FunOil 0.5% + | 12.0 | 5.0 | 13.3 | 10.0 |
| Tween20 0.2% | | | | |
| AGR- FunOil 1% + | 12.0 | 5.0 | 26.7 | 10.0 |
| Tween20 0.2% | | | | |
| Conventional Control | 12.0 | 3.8 | 13.3 | 10.0 |

### Example 13. AgriCell Biofungicide as a post-Harvest Application for Biofungicides

Evaluation of fungicides for postharvest control of black rot (Ceratocystis fimbriata) in sweet potato (Ipomoea batatas ‘Covington’).

This experiment was conducted at the Central Crops Research Station in Clayton, NC. Sweet potato roots used in the study were grown at the Cunningham Research Station in Kinston, N.C. and were rinsed in water prior to use. Roots were previously cured and were selected based upon similar size, shape, and disease-free appearance. A spore suspension was created by dislodging ascospores from cultures of Ceratocystis fimbriata isolate AS186 grown on 100-mm agar plates and adding them to 190 L of water. The approximate concentration of the spore suspension was 1.0×10³ spores/ml. Sweet potatoes were placed into a 379-L bin containing the spore suspension. The spore suspension, along with the roots, were gently agitated for 20 min to ensure a homogenous solution throughout the inoculation. Following inoculation, roots were taken out of the spore suspension and allowed to air dry. Roots were then placed onto a packing line and fungicide spray treatments were applied using a compressed air pressurized sprayer delivering 0.5 gal/2,000 lb of roots at 20 psi with four TG-1 full cone nozzles. Enough product was used to ensure complete coverage of each sweet potato. After fungicide application, sweet potatoes were placed into clear, plastic containers (40×50×17.9 cm) and stored at 24° C. and 99% relative humidity for 28 days. Roots used for the non-treated control were inoculated, but had no treatments applied. Ten replications per treatment were included with 5 roots per replication. Roots were rated for disease incidence (number of lesions on each root per box) at 7, 14, 21, and 28 days after inoculation. Disease severity (percent area covered in lesions) was rated at 7, 14, 21, and 28 days after inoculation. Data were analyzed in the software ARM (Gylling Data Management, Brookings, SD) using analysis of variance (AOV) and Fisher's Protected LSD test (P=0.05) to separate means.

Black rot was first observed at 7 days after inoculation. Roots treated with Mertect 340F had the lowest incidence and severity at each rating date. Both AC-Biofun1 and AC-Biofun2 showed significantly lower incidence at all dates when compared to the nontreated control. AGR-Biofun1, AGR-Biofun2, and Mertect 340F showed significantly lower severity than the nontreated control. AGR-Biofun2 and Mertect 340F both showed significantly lower severity that the nontreated. No phytotoxicity was observed in any treatment. In the table, treatments are sorted by disease incidence.

TABLE 6

| | Disease Incidence^{z} | | | | Disease Severity^{y} | | | |
|---|---|---|---|---|---|---|---|---|
| Treatment | 28 | 21 | 14 | 7 | 28 | 21 | 14 | 7 |
| Name and Rate | DAI | DAI | DAI | DAI | DAI | DAI | DAI | DAI |
| Nontreated | 7.28 a^{x} | 6.36 a | 6.50 a | 1.30 a | 7.68 a | 3.32 a | 3.64 a | 0.78 a |
| AGR-Biofun1—3% | 5.78 b | 5.18 b | 4.40 b | 0.76 b | 6.42 ab | 1.78 a | 2.52 b | 0.58 ab |
| V/V | | | | | | | | |
| AGR-Biofun2—6% | 5.46 b | 4.80 b | 3.04 c | 0.78 b | 6.68 a | 2.06 a | 2.00 bc | 0.46 b |
| V/V | | | | | | | | |
| Mertect 340F—0.42 | 3.12 c | 2.80 c | 2.06 c | 0.70 b | 4.38 b | 1.26 a | 1.30 c | 0.54 b |
| fl/ton | | | | | | | | |

^{z}Disease incidence was calculated by the number of lesions on each sweet potato.
^{y}Disease severity was calculated by the percentage of each sweet potato covered by black rot lesions
^{x}Treatments followed by the same letter(s) within a column are not statistically different
(P = 0.05, Fisher's Protected LSD).

### NUMBERED EMBODIMENTS OF THE DISCLOSURE

Notwithstanding the appended claims, the disclosure sets forth the following numbered embodiments:

### Fungicidal Composition

1. A fungicidal composition for controlling one or more fungi comprising:
   (i) a minicell and (ii) a bioactive agent having fungicidal activity,
   wherein the bioactive agent is an essential oil;
   wherein the one or more fungi are controlled with application of said composition to a locus, and
   wherein the minicell enhances stability and fungicidal activity of said bioactive agent in an environmental stress.
2. The fungicidal composition of any one of the preceding embodiments, wherein the minicell is an achromosomal bacterial cell.
3. The fungicidal composition of any one of the preceding embodiments, wherein the minicell is capable of encapsulating the bioactive agent and wherein the bioactive agent is present within the minicell.
4. The fungicidal composition of any one of the preceding embodiments, wherein said essential oil comprises an eugenol, a geraniol, or a thymol.
5. The fungicidal composition of any one of the preceding embodiments, wherein said essential oil is an eugenol.
6. The fungicidal composition of any one of the preceding embodiments, wherein said essential oil is a geraniol.
7. The fungicidal composition of any one of the preceding embodiments, wherein said essential oil is a thymol.
8. The fungicidal composition of any one of the preceding embodiments, wherein the minicell and the active agent are present in a weight-to-weight ratio of about 5:1 to about 1:5 in the composition.
9. The fungicidal composition of any one of the preceding embodiments, wherein the minicell and the active agent are present in a weight-to-weight ratio of about 1:1.
10. The fungicidal composition of any one of the preceding embodiments, wherein the minicell is less than or equal to 1 μm in diameter.
11. The fungicidal composition of any one of the preceding embodiments, wherein the locus is a plant, a plant part thereof, or soil on which the plant grows or is supposed to grow.

12. The fungicidal composition of any one of the preceding embodiments, wherein the locus is one or more fungi.
13. The fungicidal composition of any one of the preceding embodiments, wherein the locus is one fungal-like microorganisms.
14. The fungicidal composition of any one of the preceding embodiments, of any one of the preceding embodiments, wherein said application of the fungicidal composition improves growth in one or more crops.
15. The fungicidal composition of any one of the preceding embodiments, wherein said improved growth is selected from the group consisting of preventively and/or curatively controlling pathogenic fungi and/or nematodes, resistance management, and improved plant physiology effects selected from enhanced root growth, improved greening, improved water use efficiency, improved nitrogen-use efficiency, delayed senescence and enhanced yield.
16. The fungicidal composition of any one of the preceding embodiments, wherein said environmental stress is temperature at 37° C. or higher.
17. The fungicidal composition of any one of the preceding embodiments, wherein the bioactive agent in the presence of the minicell has at least 1% higher fungicidal activity than the bioactive agent alone 24 hours after treatment of said composition.
18. The fungicidal composition of any one of the preceding embodiments, wherein said fungicidal composition further comprises a surfactant. wherein the composition is applied in a liquid form or a soluble, dry powder form.
19. The fungicidal composition of any one of the preceding embodiments, wherein at least about 10% of the bioactive agent is encapsulated by the minicell.
20. The fungicidal composition of any one of the preceding embodiments, wherein the minicell stabilizes the bioactive agent in an acidic condition, wherein the acidic condition is less than pH 7.
21. The fungicidal composition of any one of the preceding embodiments, wherein the minicell encapsulating the bioactive agent is preserved from depletion flocculation when a pH is adjusted to an extremely acidic condition.
22. The fungicidal composition of any one of the preceding embodiments, wherein the acidic condition is as low as pH 1.
23. The fungicidal composition of any one of the preceding embodiments, wherein the minicell stabilizes the bioactive agent at least 30 days at room temperature in a neutral pH condition.
24. The fungicidal composition of any one of the preceding embodiments, wherein the minicell stabilizes the bioactive agent in a thermal variation.
25. The fungicidal composition of any one of the preceding embodiments, wherein the bioactive agent encapsulated by the minicell is at least 1.1 fold more resistant to thermal degradation than a free bioactive agent not encapsulated by the minicell on day 7 after a heat treatment at 40° C.
26. The fungicidal composition of any one of the preceding embodiments, wherein the bioactive agent encapsulated by the minicell has less than about 60% thermal degradation on day 7 after a heat treatment at 40° C.
27. The fungicidal composition of any one of the preceding embodiments, wherein the minicell protects the bioactive agent from oxidative degradation by ultraviolet (UV) or visible light.
28. The fungicidal composition of any one of the preceding embodiments, wherein the bioactive agent encapsulated by the minicell is at least 1.1 fold more resistant to oxidative degradation than a free bioactive agent not encapsulated by the minicell on day 7 under UV or visible light exposure.
29. The fungicidal composition of any one of the preceding embodiments, wherein the bioactive agent encapsulated by the minicell has less than about 35% oxidative degradation on day 7 under UV or visible light exposure.
30. The fungicidal composition of any one of the preceding embodiments, wherein the minicell confers to the bioactive agent an improved stability, an enhanced bioavailability and an extended shelf life.
31. The fungicidal composition of any one of the preceding embodiments, wherein a release of the bioactive agent encapsulated by the minicell is delayed when compared to a free bioactive agent not encapsulated by the minicell.
32. The fungicidal composition of any one of the preceding embodiments, wherein a release percentage (%) of the encapsulated bioactive agent is less than about 50%in a first hour.
33. The fungicidal composition of any one of the preceding embodiments, wherein a release percentage (%) of the encapsulated bioactive agent is at least about 45% at 8 hours after the release.
34. The fungicidal composition of any one of the preceding embodiments, wherein the encapsulated bioactive agent has an extended release with less than about 50% of the bioactive agent retained at 8 hours after the release.
35. The fungicidal composition of any one of the preceding embodiments, wherein the minicell is coated by biopolymer.
36. The fungicidal composition of any one of the preceding embodiments, wherein the biopolymer is a chitosan.
37. The fungicidal composition of any one of the preceding embodiments, wherein a release of the bioactive agent encapsulated by the biopolymer-coated minicell is further delayed when compared to the encapsulated bioactive agent without the biopolymer coated.
38. The fungicidal composition of any one of the preceding embodiments, wherein the bioactive agent encapsulated by the biopolymer-coated minicell has a further extended release with at least about 10% of the bioactive agent retained, when compared to the encapsulated bioactive agent without the biopolymer coated, at 8 hours after the release.
39. The fungicidal composition of any one of the preceding embodiments, wherein the bioactive agent encapsulated by the minicell is capable of being delivered to a target in a controlled release manner.

### Method of Controlling Fungi

1. A method of controlling one or more fungi, the method comprising: applying an fungicidal composition to a locus, wherein said fungicidal composition comprising:
   (i) a minicell and (ii) a bioactive agent having fungicidal activity,
   wherein the bioactive agent is an essential oil;
   wherein the one or more fungi are controlled with application of said composition to a locus, and
   wherein the minicell enhances stability and fungicidal activity of said bioactive agent in an environmental stress.
2. The method of any one of the preceding embodiments, wherein the minicell is an achromosomal bacterial cell.
3. The method of any one of the preceding embodiments, of any one of the preceding embodiments, wherein the minicell is capable of encapsulating the bioactive agent and wherein the bioactive agent is present within the minicell.
4. The method of any one of the preceding embodiments, wherein said essential oil comprises an eugenol, a geraniol, or a thymol.
5. The method of any one of the preceding embodiments, wherein said essential oil is an eugenol.
6. The method of any one of the preceding embodiments, wherein said essential oil is a geraniol.
7. The method of any one of the preceding embodiments, wherein said essential oil is a thymol.
8. The method of any one of the preceding embodiments, wherein the minicell and the active agent are present in a weight-to-weight ratio of about 5:1 to about 1:5 in the composition.
9. The method of any one of the preceding embodiments, wherein the minicell and the active agent are present in a weight-to-weight ratio of about 1:1.
10. The method of any one of the preceding embodiments, wherein the minicell is less than or equal to 1 μm in diameter.
11. The method of any one of the preceding embodiments, wherein the locus is a plant, a plant part thereof, or soil on which the plant grows or is supposed to grow.
12. The method of any one of the preceding embodiments, wherein the locus is one or more fungi.
13. The method of any one of the preceding embodiments, wherein the locus is one or more fungal-like microorganisms.
14. The method of any one of the preceding embodiments, wherein said application of the method improves growth in one or more crops.
15. The method of any one of the preceding embodiments, wherein said improved growth is selected from the group consisting of preventively and/or curatively controlling pathogenic fungi and/or nematodes, resistance management, and improved plant physiology effects selected from enhanced root growth, improved greening, improved water use efficiency, improved nitrogen-use efficiency, delayed senescence and enhanced yield.
16. The method of any one of the preceding embodiments, wherein said environmental stress is temperature at 37° C. or higher.
17. The method of any one of the preceding embodiments, wherein the bioactive agent in the presence of the minicell has at least 1% higher fungicidal activity than the bioactive agent alone 24 hours after treatment of said composition.
18. The method of any one of the preceding embodiments, wherein said method further comprises a surfactant. wherein the composition is applied in a liquid form or a soluble, dry powder form.

### Bacterial Minicell Comprising an Essential Oil

1. A bacterial minicell comprising: an essential oil, wherein the minicell is loaded with the essential oil in a weight-to-weight ratio of about 5:1 to about 1:5, wherein about 50% w/w to about 150% w/w of the essential oil is encapsulated by the minicell, and wherein a release percentage (%) of the encapsulated essential oil is less than about 50% in a first hour.
2. The bacterial minicell as in any one of the preceding embodiments, wherein a release percentage (%) of the encapsulated essential oil is at least about 45% at 8 hours after the release.
3. The bacterial minicell as in any one of the preceding embodiments, wherein the encapsulated essential oil has an extended release with less than about 50% of the essential oil retained at 8 hours after the release.
4. The bacterial minicell as in any one of the preceding embodiments, wherein the minicell is coated by biopolymer.
5. The bacterial minicell as in any one of the preceding embodiments, wherein the biopolymer is a chitosan.
6. The bacterial minicell as in any one of the preceding embodiments, wherein a release of the essential oil encapsulated by the biopolymer-coated minicell is further delayed when compared to the encapsulated essential oil without the biopolymer coated.
7. The bacterial minicell as in any one of the preceding embodiments, wherein the essential oil encapsulated by the biopolymer-coated minicell has a further extended release with at least about 10% of the essential oil retained, when compared to the encapsulated essential oil without the biopolymer coated, at 8 hours after the release.
8. The bacterial minicell as in any one of the preceding embodiments, wherein the essential oil encapsulated by the minicell is capable of being delivered to a target in a controlled release manner.
9. The bacterial minicell as in any one of the preceding embodiments, wherein the essential oil comprises geraniol, eugenol, or thymol.

### Method of Preparing a Minicell Encapsulating a Bioactive Agent

1. A method of preparing an minicell encapsulating a bioactive agent, said method comprising the steps of:
   a) producing and purifying minicells;
   b) providing a bioactive agent;
   c) loading the minicells with the bioactive agent for encapsulation; and
   d) recovering the minicells encapsulating the bioactive agent.
2. The method as in any one of the preceding embodiments, wherein in step a) the minicells are produced from a bacterial cell.
3. The method as in any one of the preceding embodiments, wherein in step a) the purified minicells are provided as a suspension in water or other suitable liquid, or a concentrated paste.
4. The method as in any one of the preceding embodiments, wherein the suspension comprises about 1 to 500 mg minicells per ml.
5. The method as in any one of the preceding embodiments, wherein in step a) the purified minicells are provided as a dry powder.
6. The method as in any one of the preceding embodiments, wherein in step b) the bioactive agent provided as a suspension in an aqueous solvent.
7. The method as in any one of the preceding embodiments, wherein in step c) the loaded minicells are suspended in a suspension of the bioactive agent.
8. The method as in any one of the preceding embodiments, wherein in step c) the reaction is carried out at atmospheric pressure at a temperature of about 1° C. to about 40° C.
9. The method as in any one of the preceding embodiments, wherein in step c) the loading ratio between the minicells and the bioactive agent is about 1:5 to about 5:1.
10. The method as in any one of the preceding embodiments, further comprising the step of drying the minicells encapsulating the bioactive agent.
11. The method as in any one of the preceding embodiments, wherein the drying of the minicells encapsulating the bioactive agent is by evaporating a solvent.
12. The method as in any one of the preceding embodiments, wherein the bioactive agent is an essential oil.
13. The method as in any one of the preceding embodiments, wherein the essential oil comprises geraniol, eugenol, or thymol.

### Method of Delivering a Bioactive Agent to a Locus

1. A method of delivering a bioactive agent to a subject, the method comprising: applying to the locus with a fungicidal composition as in any one of the preceding embodiments.
2. The method as in any one of the preceding embodiments, wherein the locus is a plant, a plant part thereof, or soil on which the plant grows or is supposed to grow.
3. The method as in any one of the preceding embodiments, wherein the locus is one or more fungi.
4. The method as in any one of the preceding embodiments, wherein the locus is one fungal-like microorganisms.
5. The method as in any one of the preceding embodiments, wherein the bioactive agent is an essential oil.
6. The method as in any one of the preceding embodiments, wherein the bioactive agent has an fungicidal activity.

### INCORPORATION BY REFERENCE

All references, articles, publications, patents, patent publications, and patent applications cited herein are incorporated by reference in their entireties for all purposes. However, mention of any reference, article, publication, patent, patent publication, and patent application cited herein is not, and should not, be taken as an acknowledgment or any form of suggestion that they constitute valid prior art or form part of the common general knowledge in any country in the world.

### REFERENCES

U.S. Pat. No. 3,467,604
U.S. Patent Application No. 2012/0016022
U.S. Patent Application No. 2012/0016022
U.S. Patent Application No. 2016/0174571
International Patent application No. WO 09/013361
International Patent application No. WO2018/201160
International Patent application No.WO2018/201161
International Patent application No.WO2019/060903
International Patent application No.WO2021/133846
Mitchell R R, Summer C L, Blonde S A, Bush D M, Hulburt G K, Synder E M, Giesy J P (2002) SCRAM: A scoring and ranking system for persistant, bioaccumulative and toxic substances for the North America Great lakes resulting chemical score and ranking. Human Ecol Risk Assess. 8(3): 537-557.
Helsel Z R (1987) Pesticide use in world agriculture. Alsevier New York. 2: 179-195.
Martin, G. B.; Ferasyi, T. R. Clean, Green, Ethical (CGE) Management: What Research DoWe Really Need? Int. J. Trop. Vet. Biomed. Res., 2016, 1-8
Mengoni, Y.; Adrian, M.; Pereira, S.; Santos-Carballal, B.; Kaiser, M.; Goycoolea, F. M. A chitosan-based liposome formulation enhances the in vitro wound healing efficacy of substance P neuropeptide. Pharmaceutics, 2017, 56-61
Filipovic-Grcic, J.; Skalko-Basnet, N.; Jalsenjak I. Mucoadhesive chitosan-coated liposomes: Characteristics and stability. J. Microencap., 2007, 18, 3-12
Madrigal-Carballo, S.; Rodriguez, G.; Sibaja, M.; Vila, A. O.; Reed, J. D.; Molina, F. Chitosomes loaded with cranberry proanthocyanidins attenuate the bacterial lipopolysaccharide induced expression of iNOS and COX-2 in Raw 264.7 macrophages. J. Liposome Res., 2009, 19, 89-196
Madrigal-Carballo, S.; Vila, A. O.; Sibaja, M.; Reed, J. D.; Molina, M. In vitro uptake of lysozyme-loaded liposomes coated with chitosan biopolymer as model immunoadjuvants. J. Liposome Res., 2010, 20, 1-8
Turek, C.; Stintzin, F. C. Stability of Essential Oils: A Review. Com. Rev. Food Sci. Food Safety, 2013, 12, 40-53.
Hou H, Zhang X, Zhao T, Zhou L. Effects of Origanum vulgare essential oil and its two main components, carvacrol and thymol, on the plant pathogen Botrytis cinerea. Peed. 2020;8:e9626. Published 2020 Aug. 14.
Glasl H. 1975. Uber die Haltbarkeit von Terpenoiden in Extrakten and Losungen mit unterschiedlichem Alkoholgehalt. Arch Pharm 308:88-93
Choe E, Min D B. 2006. Mechanisms and factors for edible oil oxidation. Compr Rev Food Sci Food Saf 5:169-86.

What is claimed is:

1. A fungicidal composition for controlling one or more fungi comprising:
(i) a minicell and (ii) a bioactive agent having fungicidal activity,
wherein the bioactive agent is an essential oil;
wherein the one or more fungi are controlled with application of said composition to a locus, and
wherein the minicell enhances stability and fungicidal activity of said bioactive agent in an environmental stress.

2. The fungicidal composition of claim 1, wherein the minicell is an achromosomal bacterial cell.

3. The fungicidal composition of any one of claims 1-2, wherein the minicell is capable of encapsulating the bioactive agent and wherein the bioactive agent is present within the minicell.

4. The fungicidal composition of any one of claims 1-3, wherein said essential oil comprises an eugenol, a geraniol, or a thymol.

5. The fungicidal composition of claim 4, wherein said essential oil is an eugenol.

6. The fungicidal composition of claim 4, wherein said essential oil is a geraniol.

7. The fungicidal composition of claim 4, wherein said essential oil is a thymol.

8. The fungicidal composition of any one of claims 1-7, wherein the minicell and the active agent are present in a weight-to-weight ratio of about 5:1 to about 1:5 in the composition.

9. The fungicidal composition of claim 8, wherein the minicell and the active agent are present in a weight-to-weight ratio of about 1:1.

10. The fungicidal composition of claim 1, wherein the minicell is less than or equal to 1 μm in diameter.

11. The fungicidal composition of claim 1, wherein the locus is a plant, a plant part thereof, or soil on which the plant grows or is supposed to grow.

12. The fungicidal composition of claim 1, wherein the locus is one or more fungi.

13. The fungicidal composition of claim 1, wherein the locus is one or more fungal-like microorganisms.

14. The fungicidal composition of claim 1, wherein said application of the fungicidal composition improves growth in one or more crops.

15. The fungicidal composition of claim 1, wherein said improved growth is selected from the group consisting of preventively and/or curatively controlling pathogenic fungi and/or nematodes, resistance management, and improved plant physiology effects selected from enhanced root growth, improved greening, improved water use efficiency, improved nitrogen-use efficiency, delayed senescence and enhanced yield.

16. The fungicidal composition of claim 1, wherein said environmental stress is temperature at 37° C. or higher.

17. The fungicidal composition of claim 1, wherein the bioactive agent in the presence of the minicell has at least 1% higher fungicidal activity than the bioactive agent alone 24 hours after treatment of said composition.

18. The fungicidal composition of any one of claims 1-17, wherein said fungicidal composition further comprises a surfactant. wherein the composition is applied in a liquid form or a soluble, dry powder form.

19. A method of controlling one or more fungi, the method comprising: applying an fungicidal composition to a locus, wherein said fungicidal composition comprising:
(i) a minicell and (ii) a bioactive agent having fungicidal activity,
wherein the bioactive agent is an essential oil;
wherein the one or more fungi are controlled with application of said composition to a locus, and
wherein the minicell enhances stability and fungicidal activity of said bioactive agent in an environmental stress.

20. The method of claim 19, wherein the minicell is an achromosomal bacterial cell.

21. The method of any one of claims 19-20, wherein the minicell is capable of encapsulating the bioactive agent and wherein the bioactive agent is present within the minicell.

22. The method of any one of claims 19-21, wherein said essential oil comprises an eugenol, a geraniol, or a thymol.

23. The method of claim 22, wherein said essential oil is an eugenol.

24. The method of claim 22, wherein said essential oil is a geraniol.

25. The method of claim 22, wherein said essential oil is a thymol.

26. The method of any one of claims 19-25, wherein the minicell and the active agent are present in a weight-to-weight ratio of about 5:1 to about 1:5 in the composition.

27. The method of claim 26, wherein the minicell and the active agent are present in a weight-to-weight ratio of about 1:1.

28. The method of claim 19, wherein the minicell is less than or equal to 1 μm in diameter.

29. The method of claim 19, wherein the locus is a plant, a plant part thereof, or soil on which the plant grows or is supposed to grow.

30. The method of claim 19, wherein the locus is one or more fungi.

31. The method of claim 19, wherein the locus is one or more fungal-like microorganisms.

32. The method of claim 19, wherein said application of the method improves growth in one or more crops.

33. The method of claim 19, wherein said improved growth is selected from the group consisting of preventively and/or curatively controlling pathogenic fungi and/or nematodes, resistance management, and improved plant physiology effects selected from enhanced root growth, improved greening, improved water use efficiency, improved nitrogen-use efficiency, delayed senescence and enhanced yield.

34. The method of claim 19, wherein said environmental stress is temperature at 37° C. or higher.

35. The method of claim 19, wherein the bioactive agent in the presence of the minicell has at least 1% higher fungicidal activity than the bioactive agent alone 24 hours after treatment of said composition.

36. The method of any one of claims 19-35, wherein said method further comprises a surfactant. wherein the composition is applied in a liquid form or a soluble, dry powder form.
